(19) United States
(12) Patent Application Publication
(10) Pub. No.: US 2014/0030306 A1
(43) Pub. Date: Jan. 30, 2014

(54) METHODS AND COMPOSITIONS FOR REMEDIATING MICROBIAL INDUCED CORROSION AND ENVIRONMENTAL DAMAGE, AND FOR IMPROVING WASTEWATER TREATMENT PROCESSES

(71) Applicants: David Matthew Polizzotti, Trevose, PA (US); Cato Russell McDaniel, Montogomery, TX (US); Claudia C. Pierce, Trevose, PA (US); Stephen Robert Vasconcellos, Trevose, PA (US)

(72) Inventors: David Matthew Polizzotti, Trevose, PA (US); Cato Russell McDaniel, Montogomery, TX (US); Claudia C. Pierce, Trevose, PA (US); Stephen Robert Vasconcellos, Trevose, PA (US)

(73) Assignee: General Electric Company, Schenectady, NY (US)

(21) Appl. No.: 14/008,942

(22) PCT Filed: Mar. 29, 2012
(86) PCT No.: PCT/US2012/031091

§ 371 Date: Sep. 30, 2013

Related U.S. Application Data
(60) Provisional application No. 61/470,828, filed on Apr. 1, 2011.

(51) Int. Cl. A01N 63/00

(52) U.S. Cl. CPC A01N 63/00
USPC 424/420; 424/93.6

(57) ABSTRACT

A method for remediating bacterially-induced corrosion, environmental damage, and/or process inefficiencies in an industrial process includes identifying an industrial process where target bacteria adversely affect corrosion, environmental impact, and/or process efficiencies. The process also includes identifying the strains of the target bacteria, obtaining a bacteriophage virulent against one or more of the strains of the target bacteria, and exposing the target bacteria to the bacteriophage. The method can utilize an aqueous composition comprising bacteriophage encapsulated in at least one selected from the group consisting of: liposomes, foam, and gel.

### FIELD OF INVENTION

The field of the invention relates to methods and compositions for remediating microbially induced corrosion and environmental damage in water and non-water applications, as well as improving wastewater treatment processes. More particularly, the invention relates to the use of bacteriophages to remediate corrosion, pollution, and wastewater treatment inefficiencies induced by bacteria.

### BACKGROUND OF THE INVENTION

Bacteria are known to induce corrosion in a variety of water and non-water applications, as well as catalyzing the creation of acid in certain circumstances. Typically, control of such bacteria takes place with the use of chemical biocides (“biocides”). However, this can have adverse environmental impact due to the discharge of such chemicals into the environment, and such chemicals may attack benign bacteria and other organisms upon discharge. Additionally, large amounts of chemicals may be needed for effective elimination of bacteria, which can increase costs. Additionally, such chemicals may not be effective in treating the target bacteria. Accordingly, there is a need for environmentally friendly ways to control bacterial growth, preferably at a reasonable cost, which is effective for the particular target bacteria but will not harm other bacteria. The present invention addresses such need with the use of bacteriophages (otherwise also referred to as “phage” or “phages”).

To better understand the origin and use of phage, the following background information is provided.

Viruses, from the Latin, meaning “poison”, straddle the definition of life. They lie somewhere between large molecular complexes and very simple biological entities. Viruses contain some of the structures and exhibit some of the activities that are common to organic life, but they are missing many of the others. In general, viruses are entirely composed of a single strand of genetic information encased within a protein capsule. Viruses lack the internal structure and machinery which characterize ‘life’, including the biosynthetic machinery that is necessary for non parasitic reproduction. In order for a virus to replicate it must infect a suitable host cell.

Viruses exist in two distinct states. When not in contact with a host cell, the virus remains entirely dormant. During this time there are no internal biological activities occurring within the virus, and in essence the virus is no more than a static organic particle. In this simple state viruses are referred to as ‘virions’. Virions can remain in this dormant state for extended periods of time, until chance brings them into contact with the appropriate host. When the virion comes into contact with the appropriate host, it becomes active and is then referred to as a virus. It now displays properties typified by living organisms, such as reacting to its environment and directing its efforts toward self-replication.

Bacteriophage, from the Greek phagein, meaning “to eat”, is a virus that only infects bacteria. It exists as an inactive virion until one of its extended ‘legs’ comes into contact with the surface of an appropriate bacterium. Sensors on the ends of the bacteriophage's ‘legs’ recognize binding sites on the surface of a specific host cell and bind to that surface. It then punctures the cell with its injection tube, and injects its own genetic blueprint. This genetic information subverts the host cell's normal operation and sets the cell's biosynthetic machinery to work creating replicas of the virus. These newly created viruses cause the bacteria to swell and burst. In so doing, they release new phages that then float about dormant until one happens to come into contact with a new host cell.

Bacteriophage infect only bacteria and hence attack only prokaryotes. Even in the case of prokaryotes, the bacteriophage must be capable of infecting and subverting the host cell. Hence there is a natural specificity between bacteriophage and bacteria. Bacteriophage cannot infect eukaryotes, hence there is no chance that a bacteriophage can attack an animal or human cell and is therefore safe and environmentally friendly, not to mention natural if obtained from the environment itself

### SUMMARY OF THE INVENTION

The present invention is directed to a method for remediating bacterially-induced corrosion, environmental damage, and/or process inefficiencies in an industrial process. Such method includes identifying an industrial process where target bacteria adversely affect corrosion, environmental impact, and/or process efficiencies, identifying the strains of target bacteria, obtaining a bacteriophage virulent against one or more of the strains of the target bacteria, and exposing the target bacteria to the bacteriophage. The industrial processes include mining, hydraulic fracturing, cooling tower operation, transporting hydrocarbons in pipelines, and wastewater treatment. The method can utilize an aqueous composition comprising bacteriophage encapsulated in at least one selected from the group consisting of: liposomes, foam, and gel.

The various features of novelty that characterize the invention are pointed out with particularity in the claims annexed to and forming a part of this disclosure. Changes to and substitutions of the components of the invention can of course be made. The invention resides as well in sub-combinations and sub-systems of the elements described, and in methods of using them.

### BRIEF DESCRIPTION OF THE SEVERAL VIEWS OF THE DRAWINGS

FIG. 1 shows the results of using phage against planktonic bacteria.

FIG. 2 shows the results of using phage against planktonic bacteria at a lesser concentration of phage than FIG. 1.

FIG. 3 shows the results of using phage against planktonic bacteria at a lesser concentration of phage than FIG. 2.

FIG. 4 shows the results of using phage against planktonic bacteria at a greater concentration of phage than FIG. 1.

FIG. 5 shows the results of using phage against planktonic bacteria at a greater concentration of phage than FIG. 4.

FIG. 6 shows the results of using phage against sessile bacteria.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about,” are not limited to the precise value specified. In at least some instances, the approximating language may correspond to the precision of an instrument for measuring the value. Range limitations may be combined and/or interchanged, and such ranges are identified and include all the sub-ranges included therein unless context or language indicates otherwise, and are deemed to provide support for all of the sub-ranges included therein. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

In the present disclosure, the term ppm is defined as parts per million on a weight basis (e.g., micrograms per gram). The term “phage” shall be interpreted to be a plural word (i.e., more than one bacteriophage), unless the disclosure states otherwise or the context requires otherwise. The term planktonic bacteria shall be interpreted to be bacteria which is suspended or floating in a fluid environment. The term sessile bacteria shall be interpreted to be bacteria formed in colonies on solid surfaces, such as biofilms on surfaces. It is possible for the same species of bacteria to be present as planktonic bacteria (if suspended) and/or sessile bacteria (if on a surface).

The present invention offers an alternative to chemical biocides for aqueous applications. This alternative is environmentally friendly, is specific to the bacteria that is to be controlled, can be cost-effective, and can be effective against bacteria which is difficult to treat with chemical biocides. There are several applications envisioned by the present invention, as will be more specifically described below.

There are a number of bacteria that are particularly problematic, and for which phages are particularly useful against. One example is sulfate-reducing bacteria, which can produce hydrogen sulfide, which can cause sulfide stress cracking Acidithiobacillus bacteria produce sulfuric acid. Acidithiobacillus thiooxidans, a sub-genus of Acidithiobacillus bacteria, frequently damages sewer pipes. Ferrobacillus ferrooxidans directly oxidizes iron to iron oxides and iron hydroxides. Other bacteria produce various acids, both organic and mineral, or ammonia.

In the presence of oxygen, aerobic bacteria like Thiobacillus thiooxidans, Thiobacillus thioparus, and Thiobacillus concretivorus, all three widely present in the environment, are the common corrosion-causing factors resulting in biogenic sulfide corrosion.

Without presence of oxygen, anaerobic bacteria, especially Desulfovibrio and Desulfotomaculum, are common. Desulfovibrio salixigens requires at least 2.5% concentration of sodium chloride, but D. vulgaris and D. desulfuricans can grow in both fresh and salt water. D. africanus is another common corrosion-causing microorganism. The Desulfotomaculum genus comprises sulfate-reducing spore-forming bacteria. Dtm. orientis and Dtm. nigrificans are involved in corrosion processes. Sulfate-reducers require a reducing environment, and an electrode potential of at least −100 mV is required for them to thrive. However, even a small amount of produced hydrogen sulfide can achieve this shift, so the growth, once started, tends to accelerate.

Layers of anaerobic bacteria can exist in the inner parts of the corrosion deposits, while the outer parts are inhabited by aerobic bacteria. Some bacteria are able to utilize hydrogen formed during cathodic corrosion processes.

Bacterial colonies and deposits can form concentration cells, causing and enhancing galvanic corrosion. Bacterial corrosion may appear like pitting corrosion. Anaerobic corrosion is evident as layers of metal sulfides and hydrogen sulfide smell. On cast iron, a graphitic corrosion selective leaching may be the result, with iron being consumed by the bacteria, leaving a graphite matrix with low mechanical strength in place.

Microbial corrosion can also apply to plastics, concrete, and many other materials. One such example is Nylon-eating bacteria. The present invention is directed to the use bacteriophage to control microbial induced corrosion, to reduce environmental damage, and to assist wastewater treatment. Specifically, the present invention is directed to utilizing one or more types of phage with or without the addition of one or more biocides or biodispersants to control bacteria. The phage may or may not be contained within a liposome or other time release technology that delivers the phage into a target bacterial biofilm wherein microbially induced corrosion or environmental damage is taking place. Phage are very specific, hence the need for a cocktail for broad based protection would be useful, but can be supplemented with other biocides or biodispersants to provide an effective solution. If the phage is utilized in combination with chemical biocides, this can reduce the amount of chemical biocides needed. Also, this can broaden the potential bacteria that can be controlled with the treatment since a mix of many different kinds of bacteria would require a mix of many matching different types of phage. Thus, phage can be utilized to attack the dominant bacteria and/or the bacteria that is the least susceptible to attack by biocides, and the remaining bacteria can be attacked by other biocides. The control of the bacteria will preferably include killing bacteria to ensure that the number of bacteria does not increase and, preferably, decreases.

While the specific embodiment described above relates to the problem of microbial induced corrosion via sulfate reducing bacteria, the method of using bacteriophage is completely general, and it provides a “green” biocide alternative to those currently used in cooling towers and other water and non water uses requiring microbial control. It is recognized that the specificity of bacteriophage may make them impractical for use in locations where there are many types of bacteria to eliminate all such bacteria. However, the concept of having a replicating “kill” specific to the most common or dominant bacteria in a given application, may be attractive. Moreover, as stated above, such bacteriophage can be used in conjunction with bacteriocides to broaden the scope of application. In fact, in the case of biofilms, even if the phage “cocktail” utilized to attack the biofilm is insufficient to kill all of the bacteria contained in the biofilm, the destruction of the main bacteria in a biofilm can make it easier for dispersants to wash away the biofilm and facilitate penetration and activity of other biocides. Moreover, the destruction of the upper aerobic bacterial layer in a biofilm by phage will expose the anaerobic bacteria underneath to oxygen, which would be adverse to such anaerobic bacteria. Thus, the use of bacteriophage can adversely affect biofilms in a number of ways.

A bacteriophage must be able to adsorb, penetrate, multiply, and release. To adsorb, the phage must be able to recognize a specific receptor on the surface of the host bacterium in order to adsorb to the surface of the cell. To penetrate, the phage must be able to inject its DNA through the cell wall and membrane of the bacterium to the inside. To be recognized, the phage DNA must be recognized by the host cell's replicative and transcriptional machinery before it becomes more than a piece of inert DNA and is broken down (hence the specificity). To multiply, the phage must be able to replicate its DNA, synthesize new capsid proteins, tail fiber proteins, etc., and any proteins required for packaging the phage DNA into the capsids. To release, once assembled, the phage must be able to get out of the host cell to find new host cells to adsorb to, etc.

In order to target a particular bacteria, the target bacteria should be identified. In the case of biofilms, a sample of such biofilm would be helpful in identifying the bacteria that are present. In the case of aqueous systems that contain unwanted bacteria, samples of the fluids can provide sources for the bacteria. In some cases, the types of bacteria that are present in certain environments (such as some sulfate-reducing bacteria) are well-known and sampling may not be necessary since the well-known bacteria may already be commercially available. Thus, there are various ways to identify the bacteria that is to be controlled (i.e., whose population is to be kept constant, or, preferably, whose population is to decrease substantially or to disappear). The method of obtaining, identifying, and growing bacteria is well known in the art and a thorough explanation is not necessary in the present description.

The next step is to obtain a phage which is specific enough to the target bacteria that was identified. There are a number of ways to obtain such phage. For example, bacteriophage from the surroundings of where the target bacteria are found can be obtained, such as from soil samples, water samples, underground samples, and the target bacteria themselves. It is believed that phage are widely distributed, and in an area where a particular bacteria is present, the phage for that bacteria are also likely to be present. Preferably, in order to obtain a match between the phage that is found and the bacteria that is to be attacked, the soil, water, etc. to be utilized to get phage should be in close proximity to where the target bacteria are located, and/or where they originated (in the case that water or other materials are pumped long distances and the source is far from the corrosion and environmental problems caused by the bacteria). For example, soil samples near a cooling tower or mine, or other locations of unwanted bacteria can be a source of pertinent phage. The effluent water from cooling towers may also contain phage that has had an opportunity to interact with some of the bacteria that remains therein. The method of obtaining phage is well known in the art and a thorough explanation is not necessary in the present description.

Once a sample is identified that may contain the desired phage, such as soil, such sample can be exposed to a medium containing the target bacteria and nutrients for the target bacteria. To the extent there is any phage in the phage sample that is specific to the bacteria, such phage will attack the target bacteria and multiply inside the bacteria. Thus, phage specific to the target bacteria can be grown, and if more phage are desired, more target bacteria can just be added as “food” for the phage to continue to multiply. The phage can then be filtered, such as by vacuum filtration with a pore size being 0.2 micrometers. The method of growing phage is well known in the art and a thorough explanation is not necessary in the present description.

Another potential way to obtain phage is from companies that sell phage, assuming that one is available against the particular target bacteria. The Federal State Scientific-Industrial Company for Immunological Medicines of the Ministry of Health of the Russian Federation MICROGEN is an example of a company that sells bacteriophage against a number of bacteria. Another way to obtain the particular bacteriophage against a target bacteria is to begin with phage that may not be effective against that particular bacteria and mix large numbers of the phage with large numbers of the target bacteria. The process of natural selection will allow phage that naturally evolve to be able to attack the target bacteria. The evolution of phage in this respect can be accelerated by chemical or other means. For example, mutagenic agents can be added to the medium containing the phage, such as free radicals. Also, the phage can be exposed to ultraviolet radiation. It is also possible to utilize genetic engineering to produce a phage that is effective against a particular bacteria.

U.S. Patent Application Publication No. 2009/0180992, titled Compositions and Methods for the Treatment, Mitigation and Remediation of Biocorrosion, U.S. Patent Application Publication No. 2010/0243563 titled Process for Remediating Biofouling in Water Systems with Virulent Bacteriophage, and U.S. Patent Application Publication No. 2011/0215050 titled Control of Filamentous Bacteria Induced Foaming in Wastewater Systems explain how to obtain phage that are effective against target bacteria. The disclosures of U.S. Patent Application Publication Nos. 2009/0180992, 2010/0243563, and 2011/0215050 are incorporated by reference herein in their entireties.

There are specific applications envisioned by the present invention to reduce the corrosion associated with bacteria. The applications described below are not intended to limit the concept of the present invention, and are merely illustrative of how bacteriophage may be used to control bacterially induced corrosion and to reduce environmental pollution.

Acid Mine Drainage and Frac Applications

Acid Mine Drainage

In acid mine drainage, bacterial growth can increase acidity in the environment. In acid mine drainage, a reaction scheme exists for the creation of acid and, therefore, potential environmental damage. The problem of acid mine drainage is recognized throughout the world as a severe environmental problem. The origin of acid mine drainage is the weathering and oxidation of pyritic and other sulfide containing minerals via the chemistry shown below:

### The Four Generally Accepted Reactions that Represent Acid Mine Drainage are as follows:

2FeS₂+7O₂+2H₂O→2Fe²⁺+4SO₄²⁻+4H⁺

Pyrite+Oxygen+Water→FerousIron+Sulfate+Acidity

4Fe²⁺+O₂+4H³⁰ →4Fe³⁺+2H₂O

FerrousIron+Oxygen+Acidity→FerricIron+Water

4Fe³⁺+12H₂O→4Fe(OH)₃↓+12H⁺

FerricIron+Water→FerricHydroxide(yellowboy)+Acidity

FeS₂+14Fe³⁺+8H₂O→15Fe²⁺+2SO₄²⁻+16H⁺

Pyrite+FerricIron+Water→FerrousIron+Sulfate+Acidity

The acidity which is generated solubilizes heavy metals contained in the ore in the mine, and this results in costly and significant environmental damage as the metal laden, extremely low pH water is discharged into aquifers.

Microbes play a role in accelerating the rate of weathering. For example, at pH 3.5 or less, bacteria such as Thiobacillus ferrooxidans accelerate the rate of converstion of Fe²⁺ to Fe³⁺ thereby enhancing the weathering reactions noted above. Such bacteria may accelerate reactions by orders of magnitude. Hence the role of microbiology is secondary and somewhat catalytic to the primary weathering of pyrite. The present invention is directed to providing a phage that can attack Thiobacillus ferrooxidans and shut down the secondary path for accelerating acid mine drainage.

The methods used to treat acid mine drainage today deal with the problem after it is created. These methods involve constructed wetlands (i.e. passive water treatment), soil removal/admixture, capping, and active water treatment with commodity chemicals such as lime and soda ash in conjunction with coagulants and flocculants to facilitate settling. A discussion of the pros and cons of these methods is beyond the scope of the present disclosure. It will be noted that none of these methods control the root cause of the problem and none address the microbial component responsible for weathering of pyrite.

Biocides and/or biocide containing gels (including acrolein and on site acrolein generators) sprayed onto mine surfaces could be utilized for the purpose of shutting down the secondary weathering effect caused by microbes, but the cost, and environmental impact of using toxic materials are not acceptable. Often, the discharge from an acid mining operation goes into an aquifer. Fish live there and biocides are not good for aquatic life, so this would require detoxification, which is not a good or easy thing to do.

Phage offers an environmentally friendly alternative to reduce the effect of microbially enhanced mine waste discharge, in a way that would pose no harm to wildlife or to streams receiving the outflow from a phage treated site. It is also possible to use phage in combination with other agents such as, but not limited to, biocides.

The present invention is directed to adding phage, either in water (or aqueous solution), foam, or a gel, to the site expected to harbor bacteria that enhance rock weathering reactions contributing to acid mine drainage. The phage can be encapsulated in a liposome or other encapsulant while being present in the water, foam, or gel. Indeed, in some cases, the gel or foam carrier can be used to help cut off the main weathering reactions by preventing atmospheric oxygen from participating in the weathering reactions which are the main cause of the problem. Hence the delivery means coupled with a microbially active component provides an effective system of remediation that treats both primary and secondary causes of acid mine water production.

Hydraulic Fracturing

Hydraulic fracturing is a method to fracture rock formations to facilitate the extraction of gas and other hydrocarbons. Many references describe hydraulic fracturing. For example, see Study Guide Marcellus Shale Natural Gas: From the Ground to the Customer League of Women Voters of Pennsylvania, which is incorporated by reference herein in its entirety.

Essentially, once a gas bearing formation is identified, wells are bored into the earth in both vertical and horizontal directions to access the gas. Details as to the construction of the wells, their depth, etc. are contained in the referenced study guide.

The wells are then used to fracture the shale using high pressure water, sand and a plethora of chemicals to maintain the fractures and fissures from being closed by the intense pressure of the overburden once the hydrofracturing is completed. Millions of gallons of water are used to frac a well. Between 30% and 70% of the frac fluid returns to the surface as “flowback”. Flowback contains any matter that is dissolved in the frac water, including salt. What is dissolved depends on the location. The flowback is held in plastic lined pits at the well site until it is trucked and treated prior to disposal. At some point in time the high flow and relatively low salinity water converts to a lower flow, but much higher salinity “produced water” to distinguish it from “flowback” water.

In either case the problem of microbially induced corrosion (MIC) exists. Of particular interest are the sulfate reducing bacteria. In engineering, sulfate-reducing bacteria can create problems when metal structures are exposed to sulfate-containing water: interaction of water and metal creates a layer of molecular hydrogen on the metal surface; sulfate reducing bacteria then oxidize the hydrogen while creating hydrogen. There are a number of bacteria that are particularly problematic in this regard. For example, Acidithiobacillus bacteria produce sulfuric acid. Acidithiobacillus thiooxidans, a sub-genus of Acidithiobacillus bacteria, frequently damages sewer pipes. Ferrobacillus ferrooxidans directly oxidizes iron to iron oxides and iron hydroxides. In fact, the rusticles forming on the RMS Titanic wreck are caused by bacterial activity. Other bacteria produce various acids, both organic and mineral, or ammonia.

In the presence of oxygen, aerobic bacteria like Thiobacillus thiooxidans, Thiobacillus thioparus, and Thiobacillus concretivorus, all three widely present in the environment, are the common corrosion-causing factors resulting in biogenic sulfide corrosion.

Without presence of oxygen, anaerobic bacteria, especially Desulfovibrio and Desulfotomaculum, are common. Desulfovibrio salixigens requires at least 2.5% concentration of sodium chloride, but D. vulgaris and D. desulfuricans can grow in both fresh and salt water. D. africanus is another common corrosion-causing microorganism. The Desulfotomaculum genus comprises sulfate-reducing spore-forming bacteria. Dtm. orientis and Dtm. nigrificans are involved in corrosion processes. Sulfate-reducers require a reducing environment, and an electrode potential of at least −100 mV is required for them to thrive. However, even a small amount of produced hydrogen sulfide can achieve this shift, so the growth, once started, tends to accelerate.

It is the latter group of organisms (i.e., those in anaerobic environments) that are of main concern in this invention because many of the operations involved in hydraulic fracturing lend themselves to an anaerobic environment. For example, in well heads and casings that go deep underground, oxygen is typically not available. Hence, organisms introduced into the well which are carried by surface water used to fracture the formation quickly become anaerobic environments and will foster the growth of anaerobic microbes. In the case of the flowback or produced water disposal, in many cases the propants used (i.e. sand) are a component of the flowback water. This water is held in ponds or tank farms for disposal. As the sand settles to the bottom of the tank, pond oxygen is excluded and the environment in and between the sand granules quickly becomes anaerobic and again fosters the formation of sulfate reducing bacteria. These bacteria in turn create corrosive environments adjacent to the mild steel tanks often used to contain the flowback prior to deep well injection or some other treatment. In any case, the corrosive environment creates failures in the containment vessels and these subsequently leak.

In a similar way, this water is finally sent to deep well disposal and in that case the already formed corrosive bacteria are transferred to the mild steel casings of the disposal wells. These bacteria will colonize along the surface of the well casing and again due to anaerobic conditions the bacteria will create corrosion and compromise the integrity of the deep well.

In the case of shale, the frac fluids are collected and in many cases are sent to a tank farm for down hole disposal. In the tank farm, solids from the frac process settle to the bottom and apparently bring or become a breeding place for microbes. Since the sand layer is deficient in oxygen, an anaerobic environment is established. The sulfates contained in the water, in the absence of oxygen, are reduced by sulfate reducing bacterias (SRB's) to form H₂S via biochemical reactions. Once the H₂S is formed, it is free to interact with structural materials (steel, concrete, etc) and eventually corrode and weaken the structure to failure. This problem persists not only in the frac tank holding area, but also down hole in the shale formation itself and can cause corrosion in the pipes forming the casing of the well.

Also, the corrosion of iron-containing components can be especially detrimental. Oxidation of iron to iron(II) and reduction of sulfate to sulfide ion with resulting precipitation of iron sulfide and generation of corrosive hydrogen ions in situ may take place via the sulfate reducing bacteria. The corrosion of iron by sulfate reducing bacteria is rapid and, unlike ordinary rusting, it is not self-limiting. Tubercles produced by Desulfovibrio consist of an outer shell of red ferric oxide mixed with black magnetic iron oxide, containing a soft, black center of ferrous sulfide. A technical explanation follows in view of chemical Equations (I)-(VI) below.

8H₂O→8H³⁰+8OH⁻ (I)

4Fe+8H³⁰→4Fe⁺²+8H (II)

SO₄⁻²+8H→H₂S+2H₂O+2OH⁻ (III)

Fe⁺²°8H→H₂S+2H₂O+2OH⁻ (IV)

3Fe⁺²+6OH⁻→3Fe(OH)₂ (V)

4Fe+SO₄⁻²+4H₂O→FeS+3Fe(OH)₂OH³¹ (VI)

Equations I and II represent the anodic dissolution of iron. Equation III, the essential step, represents cathodic depolarization through a hydrogenase enzyme, by which sulfate-reducing bacteria reduces sulfates to hydrogen sulfide. This organism thus participates directly in the corrosion process by consuming the monatomic layer of adsorbed elemental hydrogen atoms produced at cathodes. Equations IV and V represent the formation of corrosion products. Equation VI is the net reaction of this corrosion process.

By eliminating the sulfate-reducing bacteria, this will make an important difference in the reduction of iron dissolution by affecting Equation III. Once sulfate-reducing bacteria is identified, appropriate phage can be utilized to destroy it. Hence, in all aspects of hydraulic fracturing, sulfate reducing bacteria will create failures related to corrosion and this invention addresses this problem.

While it is possible to use biocides to control undesirable bacteria in frac applications, the use of biocides has an adverse environmental impact since they can also end up in the environment, and can damage other bacteria which are not responsible for corrosion.

It is the intention of this invention to reduce or eliminate such corrosion by using suitable compositions, such as those containing phage, phage cocktails, and combinations of phage and biocides. This will result in reduction of troublesome bacteria, with less use of biocides than is currently possible. The present invention is directed to adding phage, either in water (or aqueous solution), foam, or a gel, to the mine in order to address the acid pollution problem with better environmental results. The phage can be encapsulated in a liposome or other encapsulant while being present in the water, foam, or gel.

The first step in the use of phage is to identify which bacteria are most active. Since there are only a limited number of sulfate reducing bacteria known, including Desulfovibrionaceae such as Desulfovibrio vulgaris, Desulfovibrio desulfuricans, and Desulfovibrio postgatei, as well as Caulobacteriaceae such as C. Gallionella, and Siderophacus, and Thiobacilli, such as T thiooxidans and T. denitrificans. These bacteria are easily identified by techniques commonly used by one skilled in the art. The procedure is to identify the key sulfate reducing bacteria and/or other target bacteria in each component of the frac process (i.e. hydraulic fracturing, disposal well tankage, and deep well injection). This can be done by testing biofilms or aqueous medium present in these various components to determine the makeup of the bacteria.

Having articulated the bacteria of interest in each area, suitable phage would be obtained and cultured. The appropriate phage are generally known for the specific bacteria of interest and these could be obtained from available phage libraries and subsequently cultured and grown for commercial use. Another alternative is to screen the surrounding environment for the suitable phage, such as from the frac formations or the surrounding soil and other areas.

Once the application of phage begins, maintenance testing would also be recommended at least quarterly to ensure that the microbes responsible for the corrosion are still being remediated. In the event that a regrowth is observed, especially in spite of the application of phage, a new phage composition may need to formulated based on identifying the bacteria responsible for the corrosion. Alternatively, the phage may evolve as the bacteria evolves to continue to provide protection against microbially induced corrosion.

The method of injecting or adding the phage cocktail to the process may vary according to location. For example, in the case of the initial fracturing process, the phage may be added via a pump in the form of a time released method (e.g., via the use of a gel). Alternatively, they may be added via a pump from a concentrated or made down solution and fed from a day tank or other means. A similar method could be used in the case where the corrosion is taking place in tank farms. In this case, it may be preferable to add the phage composition prior to the flowback water being loaded into the tank farm reservoirs via a simple pump and tank assembly as already noted. Alternatively, it may be added directly to the tank farm containers as long as the contents are suitably agitated so that the phage and bacteria (e.g., on sand) are made to come into contact prior to settling in the tank. In either case, a turbulent flow is required to encourage mixing between the aqueous phage composition and the substrate (i.e. propant such as sand). In the case of deep well injection, water, foam, or gel can be used. The preferred method may involve the use of a foam (optionally tackified) or gel that can cling to the side walls of the metal casings. Such foams and gels are known and are commercially used in plumbing products to deliver drain cleaning chemicals to clogs in sewer pipes and the like. Similar gel/foam technology with or without the incorporation of time release options already described with regards to acid mine drainage can be utilized. In this way the combination of tackified gel or foam carrying phage composition may be delivered directly to the source of the corrosion which naturally grows in close association with the sidewalls of the well casings. The method of injecting such a gel or foam may be through pressurized nozzles. Additionally, two or more components may be poured into the well and the foaming/gelling action may take place internally as the fluids containing the phage make contact and mix. Gelling may take place by delayed crosslinking reactions. Foaming may take place by the use of chemicals which help to create foam.

Phage in Water as Carrier

One way to address the growth of bacteria (e.g., sessile) in mines and in fractured rock formations (“frac formation”) is to expose such bacteria to phage that is specific to the bacteria in the mines or frac formations. The application of phage for remediating bacteria is a completely general phenomenon and there is no requirement that the bacteria be a sulfate reducing bacterium. For example, in the case of acid mine drainage, bacteria that interact with the host rock to facilitate the degradation of pyrite and in a sense speed up known weathering reactions, are not the so-called sulfate reducing bacteria. The potential need for a cocktail, regardless of the mode of action of the bacteria is clear as bacterial colonies are virtually never comprised of a single bacterium. Exemplary of the bacteria that can be addressed in the present invention includes, but is not limited to: Acidithiobaccillus bacteria such as Acidithiobacillus thiooxidans; Ferrobacillus, such as Ferrobacillus ferrooxidans; Thiobacilli, such as Thiobacillus thiooxidans, Thiobacillus thioparus, Thiobacillus concretivorous, Thiobacillus denitrificans, and T. ferrooxidans; Desulfovibrionaceae such as Desulfovibrio salixigens, Desulfovibrio vulgaris, Desulfovibrio desulfuricans, Desulfovibrio africanus, and Desulfubriopostgatei; Desulfotomaculum such as Desulfotomaculum orientis and Desulfotomaculum nigrificans; Caulobacteriaceae such as C. Gallionella; and Siderophacus. The bacteria from the mines or frac formations can be cultured from samples of water that have been inside the mine or inside the frac formation and/or from samples of bacteria obtained from the walls of the mine or frac formation. Additionally, there may be bacteria that are known to be particularly problematic in mines and frac formations, and may be effective to use in a mine or frac operation even without culturing the bacteria that is in the mine due to the prevalence of these species. The phage itself can be obtained from the mines and frac formations themselves, or in the surrounding soil. Additionally, phage for SRB may also be available for purchase commercially, and may match the particular bacteria that is to be attacked in the mines and frac formations.

The phage would be included in water (or aqueous solution) that would be sprayed into the mine or frac structure. One advantage of using phage in water is that the phage is likely to thrive in water, and likely to be able to diffuse rapidly in the water in order to be able rapidly reach biofilms or planktonic bacteria that is in contact with the water. Also, if the bacteria is known to be present in a particular area, the water can be directed to such areas to maximize the killing of bacteria.

Biocides could also be utilized in the water to assist the phage in killing the bacteria. For example, if the phage kills one or more species of bacteria, and the biocide kills all or most of the rest of the problematic species of bacteria, this will significantly reduce the production of acid. The use of biocides would be reduced if used in combination with phage. In one embodiment, biocides can include non-oxidizing, oxidizing, biodispersant, and molluscicide antimicrobial compounds and mixtures thereof.

In another embodiment, suitable biocides include, but are not limited to guanidine or biguanidine salts; quaternary ammonium salts; phosphonium salts; 2-bromo-2-nitropropane-1,3-diol; 5-chloro-2-methyl-4-isothiazolin-3-one/2-methyl-4-isothiazolin-3-one; n-alkyl-dimethylbenzylammonium chloride; 2,2-dibromo-3-nitrilopropionamidemethylene-bis(thiocyanate); dodecylguanidine hydrochloride; glutaraldehyde; 2-(tert-butylamino)-4-chloro-6-(ethylamino)-s-triazine; beta-bromonitrostyrene; tributyltinoxide; n-tributyltetradecyl phosphonium chloride; tetrahydroxymethyl phosphonium chloride; 4,5-dichloro-1,2-dithiol-3-one; sodium dimethyldithiocarbamate; disodium ethylenebisdithiocarbamate; Bis(trichloromethyl) sulfone; 3,5-dimethyl-tetrahydro-2H-1,3,5-thiadiazine-2-thione; 1,2-benzisothiazolin-3-one; decylthioethylamine hydrochloride; copper sulfate; silver nitrate; bromochlorodimethylhydantoin; sodium bromide; dichlorodimethylhydantoin; sodium hypochlorite; hydrogen peroxide; chlorine dioxide; sodium chlorite; bromine chloride; peracetic acid and precursors; sodium trichloroisocyanurate; sodium trichloroisocyanurate; ethylene oxide/propylene oxide copolymers; trichlorohexanoic acid; polysiloxanes; carbosilanes; polyethyleneimine; dibromo, dicyano butane; and combinations thereof. The amount of biocide utilized can be 0.001 ppm to about 20 ppm relative to water, and any range between 0.001 ppm to about 20 ppm relative to water (or the aqueous medim) is envisioned by the present disclosure, including about 0.1 ppm to 15 ppm, 1 ppm to 10 ppm, and 3 ppm to about 8 ppm, and any ranges within those ranges. The amount of biocides should be lower than used without phage due to the fact that phage is being used to destroy major species of bacteria, such as the more problematic or more biocide resistant.

The amount of phage that could be used in the water itself would be from to 1×10³ to 1×10¹² pfu/ml (plaque forming units per milliliter of water being used to kill the bacteria), and preferably in an amount of from 1×10⁶ to 1×10¹⁰ pfu/ml. Any range between 1×10³ and 1×10¹² pfu/ml relative to the water or aqueous medium is envisioned by the present disclosure, including about 5×10³ to 1×10¹¹, and 1×10³ to 1×10¹⁰, and 1×10⁵ to 1×10⁸, and any ranges within those ranges. Plaque forming units are well known in the field of virology and no further explanation is needed in this regard. This amount of phage in the water should result in effective reduction of undesired bacteria.

One disadvantage of using phage directly in water is that the water may not result in good wetting of the mine surface or the frac formation surface. As such, if the surfaces where bacteria are present are not wetted well with the phage-containing water, then there is less likely that the phage will come into contact with these bacteria. This problem can be remedied by adding between about 0.1% to about 8% of surfactant to the water to improve wetting. Any range for the surfactant between 0.1% to 8% is envisioned by the present disclosure, including 0.5% to 6%, 1% to 5%, and any range within these ranges. Potential surfactants can include, without limitation, any one or more of the following: anionic surfactants, such as alkyl sulfates (e.g., ammonium laurel sulfate, sodium lauryl sulfate), alkyl ether sulfates (e.g., sodium laureth sulfate, sodium myreth sulfate), phosphates (e.g., alkyl aryl ether phosphate and elkyl ether phosphate), carboxylates (e.g., sodium stearate, sodium lauroyl sarcosinate), as well as cationic surfactants, such as quarternary ammonium cations (e.g., cetyl trimethylammonium bromide, cetylpyridinium chloride, benzalkonium chloride, dimethyldioctadecylammonium chloride, dioctadecyldimentylammonium bromide), and nonionic surfactants such as fatty alcohols (cetyl alcohol, searyl alcohol, oleyl alcohol), and polyoxyethylene glycol ethers (e.g., octaethylene grlycol monododecyl ether, pentaethylene glycol monododecyl ether, decyl glucoside, lauryl glucoside, octyl glucoside, glyceryl laurate, polysorbates, rorbitan alkyl esters, and dodecyldimethylamine oxide).

Another option is to use phage inside liposomes, which would result in more wetting than just water when contacting a mine surface or a frac formation surface due to the presence of the liposome. Thus, even if the water does not adequately wet or adhere to a surface, phage covered in liposomes would have increased wetting and adhesion to surfaces in this regard.

In these cases, the liposome would release the phage and the phage would attack the biofilm. In other words, the phage would be included in the liposome as an active ingredient that can be released upon penetration of the target biofilm and which can then inject its genetic material into the target bacteria.

Liposomes, or lipid bodies, are systems in which lipids are added to an aqueous buffer to form vesicles, structures that enclose a volume. More specifically, liposomes are microscopic vesicles, most commonly composed of phospholipids and water. In one embodiment, the lipid may be a phospholipid, lethicin, phosphatidyl choline, glycolipid, triglyceride, sterol, fatty acid, sphingolipid, or combinations thereof

Liposomes can be composed of naturally-derived phospholipids with mixed lipid chains (like egg phosphatidylethanolamine) or other surfactants. Examples of the phospholipids can include phosphatidylcholines (e.g., lecithin), phosphatydic acids, phosphatidylethanolamines (e.g., cephalin), phosphatidyl cerines, ceramide phosphrylcholines, ceramide phosphorylglycerols, etc.

When properly mixed, the phospholipids arrange themselves into a bilayer or multilayers, very similar to a cell membrane, surrounding an aqueous volume core. Liposomes can be produced to carry various compounds or chemicals within the aqueous core, or the desired compounds can be formulated in a suitable carrier to enter the lipid layer(s). Liposomes can be produced in various sizes and may be manufactured in submicron to multiple micron diameters. The liposomes may be manufactured by several known processes. Such processes include, but are not limited to, controlled evaporation, extrusion (e.g., pressure extrusion of a phage through a porous membrane into the lipid body or vice-versa, or pressure extrusion of a phage through a porous membrane into the lipid body), injection, sonication, microfluid processors and rotor-stator mixers. Information on liposome formation and encapsulation of other materials can be found, for example, at U.S. Pat. No. 7,824,557 and U.S. Patent Application Publication No. 2011/0052655, which are both incorporated by reference herein in their entireties. The method of incorporating phage into liposomes would be the same as the method of incorporating biocide as disclosed in U.S. Pat. No. 7,824,557 and U.S. Patent Application Publication No. 2011/0052655. Liposomes can be produced in diameters ranging from about 10 nanometers to greater than about 15 micrometers. When produced in sizes from about 100 nanometers to about 2 micrometer sizes the liposomes are very similar in size and composition to most microbial cells. The phage composition-containing liposomes are preferably produced in sizes that mimic bacterial cells, from about 0.05 to about 15 micrometers, or alternately, about 0.1 to 10.0 micrometers. However, other sizes are also appropriate. In one embodiment, the liposomes have a size of from about 0.01 micron to about 100 microns. In another embodiment, the liposomes may be from about 0.01 micron to about 50 microns. In another embodiment, the liposomes have a size of from about 0.01 micron to about 20 microns. In another embodiment, the liposomes have a size of from about 0.05 micron to about 15 microns. In another embodiment, the liposomes have a size of from about 0.1 micron to about 10 microns. In another embodiment, the liposomes have a size of from about 0.1 micron to about 2 microns. The size of the liposomes is measured directly by microscopic techniques.

In one embodiment, lipids are added to an aqueous buffer solution containing phage and mixed to form a liposome vesicle containing phage. The lipids can arrange themselves into a bilayer or multilayer microscopic vesicle, very similar to a cell membrane, surrounding an aqueous volume core containing phage. In one embodiment, the phage is within the aqueous core of the liposome. In another embodiment, the phage may be injected into the liposome and carried in one of the lipid layers.

The liposomes may be the encapsulating bodies containing the phage, or such phage may themselves be further encapsulated, e.g., by a thin shell of protective material. In the latter case, the shell may, for example, be compounded to provide a further, temporary protective cover for the liposome, such as a degradable skin, that enhances the lifetime of the liposome in the water system yet dissolves, decays or otherwise breaks down after a certain time, or under certain conditions, releasing the liposomes which may then act on the target organisms.

Another disadvantage of using water as a carrier for phage is that even if the water wets a surface, it may get washed off. Thus, before it has an effect on existing bacteria, it may be washed off. Also, if it is washed off, it will not have the same ability to preempt the growth of additional bacteria even if the existing bacteria have been eliminated. Liposomes and other encapsulants such as microencapsulation can address this problem by having greater adhesion to the wall surface than just water. If liposomes are utilized in the water to house the phage, the concentration of phage in the liposome solution would be somewhat lower than that in a solution without liposomes, namely, 1×10² to 1×10¹⁰ pfu/ml of aqueous solution. Any range within 1×10² to 1×10¹⁰ pfu/ml is envisioned in the present invention, including 5×10² to 1×10⁹ pfu/ml, 1×10² to 1×10⁷ pfu/ml, and 1×10³ to 1×10⁶ pfu/ml, and any range within these ranges. This is the case since the liposomes have better wetting of mine and frac formations, as well as better biofilm penetration capabilities due to the hydrophillicity of the outer layer of the liposome, and also the increased protection of the phage by the liposome, as explained below. It is noted that the solution including phage and liposomes will likely include the phage inside and outside the liposomes, but the liposomes will have more adhesion to walls of mines and frac structures as well as more penetration of biofilms.

Some of the environments may be inhospitable to phage, so the presence of liposomes in the water would protect the phage inside the liposomes against potentially hazardous environments to which the phage would otherwise be exposed to.

In the event that a time-release of the phage is desired in order to reduce the frequency of phage application, the phage could be microencapsulated or even macroencapsulated into particles of phage-containing solid or semi-solid materials. These materials would slowly hydrolyze and release the phage over a period of time into the water. The concentrations of phage desired in these solid or semi-solid materials would vary depending on the amount of these solid or semi-solid materials in water, and on the speed of hydrolysis. Ultimately, the desired concentration of phage in the water would be 1×10³ to 1×10¹² pfu/ml, or any range within this range, as explained above, so the concentration of phage in the solid or semi-solid materials would be appropriate to result in such phage concentration in the water.

The concentrations of phage described above are what is to be added to the aqueous solutions. However, if the phage that is added reproduces and is effective against the bacteria, the concentrations of phage that are added can then be reduced accordingly.

Micro-encapsulation is a process in which tiny agglomerations of phage are surrounded by a coating to give small capsules. In practice, it will not be just phage that will be encapsulated. Rather, it will be phage in some kind of carrier, such as water, an oil-based solvent, or even a cross-linked saccharide or polymer which will hydrolyze or dissolve in aqueous solutions. The size of these microcapsules can be from about 1 micrometer to about 5 millimeters. Techniques to manufacture microcapsules include air-suspension coating, where phage-containing droplets or particles are suspended in an upward-moving air stream and exposed to the coating material. Alternatively, the phage can be mixed with a liquid material which contains crosslinker, then separated into particles, and then crosslinked to increase viscosity and reduce tackiness. Hydroxypropylmethylcellulose can be such material. Another way to make the microcapsules is to take a phage-containing liquids and put them through a rotating extrusion head containing concentric nozzles. In this process, a jet of core liquid is surrounded by a sheath of wall solution or melt. As the jet moves through the air it breaks, owing to Rayleigh instability, into droplets of core, each coated with the wall solution. While the droplets are in flight, a molten wall may be hardened or a solvent may be evaporated from the wall solution. In spray-drying, the phage is suspended in a polymer solution and becomes trapped in the dried particle when the particle dries. Alternatively, a crosslinking reaction may be what traps the phage in the material.

It is noted that the encapsulant may encapsulate the phage in a carrier, or it can both encapsulate the phage and is also the carrier. Thus, phage in water can be encapsulated by polymer. Alternatively, phage in the polymer itself forms the microcapsule. Materials that can be used for the encapsulation include cellulose acetate, cellulose acetate butyrate, cellulose acetate phthalate, dextrins, ethyl cellulose, ethylene vinyl acetate, fats, fatty acids, gelatin, glycerides, vegetable gums, hydroxyl propyl cellulose, hydroxypropyl methyl cellulose, hydroxypropyl methyl cellulose phthalate, maltodextrins, methyl cellulose, polylactides, polyethylene glycol, polyvinyl acetate, polyvinyl alcohol, proteins, and starches. The molecular weight/crosslinking of the material can be adjusted for the particular desired hydrolysis resistance and subsequent release of phage. The thickness of the encapsulant can determine the rate of release of the phage as well.

Other materials that can be utilized to form the encapsulant, with crosslinking as necessary, are lecithin, gums, gels, biodegradable or non-biodegradable polymers, such as polylactic acid or polystyrene, organic polymers, combinations of lecithin and organically functionalized lecithin where the functionalization can either be polymer chains, peptides, proteins, lipids, cholesterols or bio receptors. The material may also be multi-block polymers containing hydrophobic and hydrophilic blocks, self-assembled donor:acceptor moieties and micelles, inorganic spheres, rods, cages or particles.

In one embodiment, the capsules may be from about 0.01 micron to about 100 microns. In another embodiment, the capsules have a size of from about 0.01 micron to about 50 microns. In another embodiment, the capsules have sizes from about 0.01 micron to about 20 microns. In another embodiment, the capsules have a size of from about 0.05 micron to about 15 microns. In another embodiment, the capsules have a size of from about 0.1 micron to about 10 microns. In another embodiment, the capsules have a size of about 0.25 micron to about 2 microns. The size of the capsules is measured directly by microscopic techniques.

It is also possible, when utilizing a combination of phage (whether in liposomes or other encapsulants, or not) and other biocides, to encapsulate the biocides in a liposome.

Phage in Foams as Carrier

In cases where higher wetting and/or adhesion to structures are desired, foam can be used to carry the phage and/or the biocide to attack bacteria (e.g., sessile). This way, better wetting and less washing off would result from application with foam. Another advantage of foam is that foam is mostly air, and therefore a much smaller amount of liquid would be needed. Thus, this would take less energy and equipment to bring water to the mine or frac operations. For example, a foaming operation can take 1 milliliter of water and end up with 35-40 milliliters of foam. Thus, foam is a way to apply an active ingredient in a large area without having to bring in a large amount of water or other carrier for the phage, except for air which is already present in essentially limitless amounts. In the present invention, between 20 and 50 milliliters of foam would be produced for every milliliter of water utilized. The present invention envisions any range within 20 and 50 milliliters of foam for every milliliter of water, including 25-45, 30-40, and any range within these ranges.

To form the foam, commonly referred to as microbubble foam, water, phage, and a foaming agent, such as a surfactant, would be utilized. The foaming agent/surfactant can be added in an amount of about 0.1% to about 10% to create the foam with a foam generator. The present invention envisions any range within the range of 0.1% to 10%, such as 0.5% to 8%, 1% to 7%, and 3% to 5%. Such surfactants can include, without limitation, any one or more alkyl benzene sulfonates, alpha olefin sulfonates, alkyl ether sulfates, alpha sulfo methyl esters, ethoxylated alkyl phenols, sulfosuccinates, betaines, sulfobetaines, linear and branched ethoxylated alcohols, and laurel vinyl sulfonates, in addition to any one or more of the surfactants identified with regards to the application of phage in water above. The actual formation of foam is well known in the art and an explanation is not necessary here. The amount of phage in the foam would be slightly higher per milliliter than it would be if the carrier medium were water since the foam will not permit as much phage to reach is destination as quickly as water due to the air pockets in the foam. A useful range for the amount of phage in the foam is 1×10⁴ to 1×10¹³ pfu/ml (plaque forming units per milliliter of foam). The present invention envisions any range within 1×10⁴ to 1×10¹³ pfu/ml, such as 5×10⁴ to 1×10¹² pfu/ml, 1×10⁵ to 1×10⁹ pfu/ml, and 1×10⁶ to 1×10⁸ pfu/ml, and any range within these ranges.

The foam can also include biocides, and these biocides can be the same as those mentioned above regarding application to water and in the same concentrations. The disclosure regarding the use of biocides above with respect to water is incorporated by reference herein in its entirety.

A combination of methodologies is also possible. For example, phage can be encapsulated in liposomes prior to being carried inside foams, in order to protect the phage against potentially damaging environments in the mine or frac formation. The concentration of phage utilized in foam that includes phage-containing liposomes would be somewhat less than without the liposomes because the liposomes increase the protection of the phage and facilitate penetration into a biofilm. Thus, about 5×10³ to 5×10¹² pfu/ml (plaque forming units per milliliter of foam) would be used. The present invention envisions any range within 5×10³ to 5×10¹² pfu/ml, such as 5×10⁴ to 5×10¹¹ pfu/ml, 5×10⁵ to 5×10¹⁰ pfu/ml, and 5×10⁶ to 5×10⁸ pfu/ml, or any range within these ranges. The liposomes themselves could be the same as the liposomes described above regarding the application to water, and the disclosure from the application to water (above) is incorporated by reference herein in its entirety.

Additionally, the phage can be encapsulated as disclosed above, whether by itself or in addition to being contained in a liposome. A description of this is found above regarding the application to water, and such disclosure is incorporated by reference herein in its entirety.

In one embodiment, the application method involves the application of phage as a foam that would stick to surfaces. In this way, the treatment may be applied (such as by spraying) to a variety of surfaces such as, but not limited to, mine walls as well as rock outcroppings, etc. The foam can be generated with turbulent mixing, and this would also help disperse the phage in the foam. The foam would then be sprayed on the target surfaces.

In the case of foam application, as the lamella break, the agents are delivered and naturally adhere to the surface. Alternatively, one may incorporate thickening or tackifying agents to the foam. Tackifying agents are well known to those skilled in the art. Over time, the phage is delivered and the microbial component responsible for enhanced weathering of iron containing waste is eliminated or reduced.

Phage in Gels as Carrier

In cases where higher wetting and/or adhesion to structures are desired, a gel can be used to carry the phage and/or the biocide to attack bacteria (e.g., sessile). In this way, less washing off would result than from application with foam. Similar to the use of foams, the use of gels which contain the phage would result in adhesion of the phage-containing gel. Furthermore, the gel can protect the phage from adverse environmental conditions. Additionally, the gel can provide a timed release mechanism to release the phage slowly as the gel dissolves. By controlling the molecular weight and crosslinking of the gel, the susceptibility to hydrolysis can be controlled, and therefore the timed release of phage can be controlled as well.

The amount of phage in the gel would be slightly higher per milliliter than it would be if the carrier medium were water since the gel will not permit as much phage to reach is destination as quickly as water due to viscosity of the gel. A useful range for the amount of phage in the gel is 1×10⁴ to 1×10¹³ pfu/ml (plaque forming units per milliliter of gel). The present invention envisions any range within 1×10⁴ to 1×10¹³ pfu/ml, such as 5×10⁴ to 1×10¹² pfu/ml, 1×10⁵ to 1×10⁹ pfu/ml, and 1×10⁶ to 1×10⁸ pfu/ml, and any range within these ranges.

A combination of methodologies is also possible. For example, phage can be encapsulated in liposomes prior to being carried inside gels. This can provide a greater degree of control of dispersion of the phage since the liposomes can be designed to be more dispersible in a particular medium than the phages would be by themselves, and could help decrease the potential agglomeration of the phage. Moreover, in environments which may be somewhat damaging to the phage, the liposomes or other encapsulants can serve to protect the phage to ensure that enough phage reach the target bacteria to penetrate and destroy it.

The kinds of gels that may be suitable include those that are readily biodegradable and environmentally benign such as those produced by PVA (polyvinylalcohol) crosslinked with boron to produce bisdiol. Other gel systems include hydroxypropylmethylcellulose (HPMC) gels, which include the HPMC in the presence of a solvent, such as methanol or another alcohol. Other gel systems can be sol gels, such as those disclosed in U.S. Pat. No. 5,229,124 which is incorporated by reference herein in its entirety. The gels can also include water and a gelling agent selected from the group consisting of xanthan gum, sodium alginate, and neutralized carboxyvinyl polymer, as disclosed in U.S. Pat. No. 6,861,075, which is incorporated by reference herein in its entirety. Other possibilities for gels include polyvinyl alcohols crosslinked with gallic or boric acids, as disclosed in U.S. Pat. No. 5,266,217, which is incorporated by reference herein in its entirety. Such polyvinyl alcohol gels can include 50-90% water, 1-20% polyvinyl alcohol, and 0.1-2% crosslinker, such as gallic acid or boric acid. The polyvinyl alcohol can be slowly added to water and mixed to dispersion, then it can be heated to 180° F. or so, to ensure dissolution. The composition can then be kept at its current temperature, or cooled somewhat to 150° F. and the crosslinker can be added. Prior to or concurrent with the addition of the crosslinker can be added the bacteriophage, to facilitate mixing due to the increase in viscosity once cross linking takes place. Another option for the gel is a polyethylene glycol, which can be heated to receive the phage to facilitate mixing. Information regarding polyethylene glycol gels can be found at, for example, U.S. Pat. No. 5,266,218 which is incorporated by reference herein in its entirety. The polyethylene glycol can have a molecular weight of 400-2000, or any range within this range, and can be a single polyethylene glycol or a mixture two or more polyethylene glycols. Silicone gels can also be utilized. Polyvinyl alcohol can be utilized, in conjunction with crosslinkers (such as borate) to increase viscosity, and surfactants to adjust surface tension to improve adhesion to the surface to be treated.

Typical surfactants can be alkyl benzene sulfonates, alpha olefin sulfonates, alkyl ether sulfates, alpha sulfo methyl esters, ethoxylated alkyl phenols, sulfosuccinates, betaines, sulfobetaines, linear and branched ethoxylated alcohols, as well as the surfactants disclosed above with regards to the application to water. The amount of polyvinyl alcohol that can be used in an aqueous solution is 0.1% to 25%, or any range within this range, and the amount of crosslinker can be 0.01% to 5%, or any range within this range. The amount of surfactants can be 0.1% to 4%, or any range within this range. Other materials can be added to the polyvinyl alcohol or to replace the polyvinyl alcohol. Such materials include starch, urea, gelatin, lignosulfonates, and soy lecithin, which may help improve adhesion to surfaces. Other materials that can be used to form foams or gels are ethylene glycol, diethylene glycol, and glycerin. Although adding the phage at a temperature higher than room temperature will increase the dispersion thereof, it is, however, appropriate to add the bacteriophage to the gel at room temperature followed by mixing to ensure proper dispersion of the bacteriophage. The incorporation of the phage into the gel can involve slowly adding the phage with mixing, or slowly adding the phage with mixing at slight to moderate heating to facilitate such mixing. The phage can be added, for example, in the same way that biocides were added in U.S. Pat. Nos. 5,266,218 and 5,266,217.

The gel could have a viscosity of about 500 to about 250,000 centipoise, such as 700-100,000, 1000-10,000, 2000-7000, or any range within this range, depending on the desired hydrolysis resistance, wetting, and adhesion to the surface to which it is applied. The amount of water or other solvent, the molecular weight, and/or the amount of crosslinking of gels can be adjusted to provide the appropriate viscosity for the desired applications.

The method for applying gels may be accomplished physically by painting or smearing the gel. The use of pressurized equipment such as spray nozzles is also contemplated herein. The gels of particular interest in the case where they are delivered via pressurized equipment would require that the viscosity of the gel be such that it would be amenable with the delivery equipment.

In an ideal scenario, phage would be sprayed onto a surface suspected of harboring bacteria of interest. The spray of gel would then adhere to the substrate (e.g., via some chemical trigger such as pH or by exploiting the properties of thixatropic fluids). In these cases, the active ingredients would adhere to the walls or substrate and not run off and be wasted. In the case of a chemical trigger using a crosslinker that is pH activated, the crosslinker can be added to the gel or to the foam right before it is applied to the desired surfaces, at which point the crosslinker would begin the reaction not much more in advance than the application of the gel or foam, and would improve the adhesion of the gel or foam to the mine surface. Another option is to apply the gel or form and the crosslinker with different nozzles over the same area. Another example is to encapsulate the crosslinker with timed-release coatings that can dissolve once the gel or foam has been applied to the desired mine surface. Another example can be a crosslinker which is slow-acting, is added a few hours before application, and eventually helps increase addition to the desired surface. Over time, the phage is delivered and the microbial component of acid mine drainage is eliminated or reduced.

The gel can also include biocides, and these biocides can be the same as those mentioned above regarding application to water and in the same concentrations. The disclosure regarding the use of biocides above with respect to water is incorporated by reference herein in its entirety.

A combination of methodologies is also possible. For example, phage can be encapsulated in liposomes contained within gels, in order to protect the phage against potentially damaging environments in the mine or frac formation. The concentration of phage utilized in gels which include phage-containing liposomes would be somewhat less without the liposomes since the liposomes provide some protection to the phage and permit better penetration of biofilms. The amount of phage in the liposomes in a gel would be about 5×10³ to 5×10¹² pfu/ml; (plaque forming units per milliliter of gel). The present invention envisions any range within 5×10³ to 5×10¹² pfu/ml, such as 5×10⁴ to 5×10¹¹ pfu/ml, 5×10⁵ to 5×10¹⁰ pfu/ml, and 5×10⁶ to 5×10⁸ pfu/ml, or any range within these ranges. The liposomes themselves could be the same as the liposomes described above regarding the application to water, and the disclosure from the application to water (above) is incorporated by reference herein in its entirety.

Additionally, the phage can be encapsulated as disclosed above, whether by itself or in addition to being contained in a liposome. A description of this is found above regarding the application to water, and such disclosure is incorporated by reference herein in its entirety.

Cooling Towers, Pipeline Corrosion, and Wastewater Treatment

Cooling Towers

The presence of bacteria in cooling towers can adversely affect the functioning of the cooling towers in several ways. For example, sulfate-reducing bacteria support the creation of acid conditions on the walls of cooling towers, heat exchangers, etc., which leads to corrosion and potential shutdown of the cooling tower while repairs are made. Additionally, biofilms on the walls of, for example, the heat exchangers, reduce the heat transfer coefficient of the heat exchangers, resulting in decreased operational efficiency of the cooling tower.

Additionally, the corrosion of iron-containing components can be especially detrimental. Oxidation of iron to iron(II) and reduction of sulfate to sulfide ion with resulting precipitation of iron sulfide and generation of corrosive hydrogen ions in situ may take place via the sulfate reducing bacteria. The corrosion of iron by sulfate reducing bacteria is rapid and, unlike ordinary rusting, it is not self-limiting. Tubercles produced by Desulfovibrio consist of an outer shell of red ferric oxide mixed with black magnetic iron oxide, containing a soft, black center of ferrous sulfide. A technical explanation follows in view of chemical Equations (I)-(VI) below.

8H₂O→8H³⁰+8OH⁻ (I)

4Fe+8H³⁰→4Fe⁺²+8H (II)

SO₄⁻²+8H→H₂S+2H₂O+2OH⁻ (III)

Fe⁺²°8H→H₂S+2H₂O+2OH⁻ (IV)

3Fe⁺²+6OH⁻→3Fe(OH)₂ (V)

4Fe+SO₄⁻²+4H₂O→FeS+3Fe(OH)₂OH³¹ (VI)

Equations I and II represent the anodic dissolution of iron. Equation III, the essential step, represents cathodic depolarization through a hydrogenase enzyme, by which sulfate-reducing bacteria reduces sulfates to hydrogen sulfide. This organism thus participates directly in the corrosion process by consuming the monatomic layer of adsorbed elemental hydrogen atoms produced at cathodes. Equations IV and V represent the formation of corrosion products. Equation VI is the net reaction of this corrosion process.

Cooling towers are air scrubbers: they use air to reduce water temperature. Any airborne bacteria or fungi will be cleaned out of the air and deposited into the cooling tower water and system. Air contains dust particles that can, and often do, contain various bacteria, fungi and algae spores. The cooling water also may contain all of these various microbiological organisms—even when treated by microbiocides—depending upon whether it is untreated raw water, treated raw water or potable water. If the system has an ineffective biocide treatment, or even an effective program, these organisms may enter and settle into an environment in which they can flourish. Microbiologically Induced Corrosion (MIC) microorganisms have been identified in many cooling tower systems that have well-maintained biocide treatment programs. MIC is due primarily to bacteria.

MIC organisms require an environment that enables their growth. These requirements include moisture, nutrients and an ideal temperature, usually 40 to 120° F. (4 to 49° C.). They can live under deposits in flowing cooling water. They can live in the presence, as well as the absence, of oxygen, ammonia, acid or alkali. They can “hibernate” at temperatures below 40° F. Usually, temperatures of 140 to 160° F. (60 to 71° C.) will kill most MIC microorganisms. Thus, in a cooling water system, there is almost always the combination of moisture, nutrients and temperature ideal for the growth and multiplication of the organisms. Most often, the presence of deposits provides an ideal environment to shield microorganisms from toxic microbiocides.

Moreover, cooling water always provides an ample supply of sulfate ions for sulfate-reducing bacteria. It is introduced in the make-up water, in sulfuric acid added to control pH, and in commercial dry chemical formulations that contain sodium sulfate as antidusting or anticaking agents. Sulfate-reducing bacteria convert sulfate ions to hydrogen sulfide as in equation III above. The bacteria are anaerobes (do not live in the presence of free oxygen). Thus, one of the MIC organisms can be sulfate-reducing bacteria, although the MIC organisms are not limited to this.

In the case of cooling towers, the use of bacteriophages and/or biocides will help eliminate the bacteria present. Even if there are deposits or current flows inside the cooling tower that would make it difficult for biocides to enter and kill the bacteria, the use of phages can be of great help. Unlike biocides, which are “used up” when they enter a bacteria, phages are actually augmented when they enter a bacteria. Thus, even if a small amount of phages reach a bacterial colony, they will then reproduce inside the bacteria and attack other members of the colony.

In one aspect of the present invention, a bacteriophage is provided which has a specific bactericidal activity against one or more sulfate reducing bacteria and other bacteria selected from the group consisting of Desulfovibrio and other sulfate reducing bacteria, including, without limitation, Desulfovibrio vulgaris, Desulfovibrio desulfuricans, and Desulfovibrio postgatei, as well as Caulobacteriaceae such as C. Gallionella, and Siderophacus, and Thiobacilli, such as T. thiooxidans, T. denitrificans and T. ferrooxidans. Other bacteria, such as legionella, while not creating corrosion, can adversely affect the performance of a cooling tower by reducing heat transfer coefficients, and should also be controlled. The bacteria that can be addressed in the present invention includes, but is not limited to: Acidithiobaccillus bacteria such as Acidithiobacillus thiooxidans; Ferrobacillus, such as Ferrobacillus ferrooxidans; Thiobacilli, such as Thiobacillus thiooxidans, Thiobacillus thioparus, Thiobacillus concretivorous, Thiobacillus denitrificans, and T. ferrooxidans; Desulfovibrionaceae such as Desulfovibrio salixigens, Desulfovibrio vulgaris, Desulfovibrio desulfuricans, Desulfovibrio africanus, and Desulfubriopostgatei; Desulfotomaculum such as Desulfotomaculum orientis and Desulfotomaculum nigrificans; Caulobacteriaceae such as C. Gallionella; Siderophacus; and Legionella.

In another aspect of the present invention, a composition is provided for the prevention or treatment of microbiologically induced corrosion caused by one or more sulfate reducing bacteria selected from the group consisting of the bacteria described above, comprising the bacteriophage as an active ingredient. Preferably, the composition is used as a cooling water treatment agent.

In another embodiment according to the present invention, a cleaner or a sanitizer is provided, and comprises the bacteriophage as an active ingredient.

Yet another aspect of the present invention is to provide a method for preventing or treating Microbiologically Induced Corrosion caused by the sulfate reducing bacteria described above, using a composition comprising the bacteriophage as an active ingredient.

One way to address the growth of bacteria in cooling towers is to expose such bacteria to phage that is specific to the bacteria in the cooling tower (whether present in the water or deposited on the cooling tower's walls as biofilm). The reference to cooling towers includes any part of the cooling tower or the heat exchanger for purposes of the present disclosure. The bacteria from cooling tower can be cultured from samples of water that have been inside the cooling tower and/or from samples of bacteria obtained from the walls of the cooling tower. The phage itself can be obtained from the cooling towers themselves, or in the surrounding soil. Additionally, phage for SRB may also be available for purchase commercially, and may match the particular bacteria that is to be attacked in the cooling towers.

One advantage of using phage in water is that the phage is likely to thrive in water (assuming that chemicals in the water are not adverse to the phage), and likely to be able to diffuse rapidly in the water in order to be able to rapidly reach biofilms or planktonic bacteria that is in contact with the water. Also, if the bacteria is known to be present in a particular area, the phage can be fed near such area (if possible).

Biocides could also be utilized in the water to assist the phage in killing the bacteria. For example, if the phage kills one or more species of bacteria, and the biocide kills all or most of the rest of the problematic species of bacteria, this will significantly reduce the production of acid underneath biofilms and also reduce the corrosion of the metal on which the biofilms are located. The use of biocides would be reduced in combination with phage than by themselves. In one embodiment, biocides can include non-oxidizing, oxidizing, biodispersant, and molluscicide antimicrobial compounds and mixtures thereof. In another embodiment, suitable biocides include, but are not limited to guanidine or biguanidine salts; quaternary ammonium salts; phosphonium salts; 2-bromo-2-nitropropane-1,3-diol; 5-chloro-2-methyl-4-isothiazolin-3-one/2-methyl-4-isothiazolin-3-one; n-alkyl-dimethylbenzylammonium chloride; 2,2-dibromo-3-nitrilopropionamidemethylene-bis(thiocyanate); dodecylguanidine hydrochloride; glutaraldehyde; 2-(tert-butylamino)-4-chloro-6-(ethylamino)-s-triazine; beta-bromonitrostyrene; tributyltinoxide; n-tributyltetradecyl phosphonium chloride; tetrahydroxymethyl phosphonium chloride; 4,5-dichloro-1,2-dithiol-3-one; sodium dimethyldithiocarbamate; disodium ethylenebisdithiocarbamate; Bis(trichloromethyl) sulfone; 3,5-dimethyl-tetrahydro-2H-1,3,5-thiadiazine-2-thione; 1,2-benzisothiazolin-3-one; decylthioethylamine hydrochloride; copper sulfate; silver nitrate; bromochlorodimethylhydantoin; sodium bromide; dichlorodimethylhydantoin; sodium hypochlorite; hydrogen peroxide; chlorine dioxide; sodium chlorite; bromine chloride; peracetic acid and precursors; sodium trichloroisocyanurate; sodium trichloroisocyanurate; ethylene oxide/propylene oxide copolymers; trichlorohexanoic acid; polysiloxanes; carbosilanes; polyethyleneimine; dibromo, dicyano butane; and combinations thereof. The amount of biocide utilized can be 0.001 ppm to about 20 ppm relative to water, and any range between 0.001 ppm to about 20 ppm relative to water is envisioned by the present disclosure, including about 0.1 ppm to 15 ppm, 0.5 ppm to 10 ppm, and 3 ppm to about 8 ppm, and any ranges within those ranges. In the case of oxidizing agents such as chlorine, 0.1 to 0.5 ppm are normally utilized, although the use can be as high as 5 ppm. The amount of biocides should be lower than used normally due to the fact that phage is being used to destroy major species of bacteria, such as the more problematic or more biocide resistant.

The amount of phage that could be used in the water itself would be from 1×10³ to 1×10¹² pfu/ml (plaque forming units per milliliter of water), and preferably in an amount of from 1×10⁶ to 1×10¹⁰ pfu/ml. In the case of sessile bacteria, the determination of how much phage to use is done in pfu/ml because it is not practical to determine the amount of bacteria per unit volume since the bacteria is clustered on surfaces in, for example, the form of biofilms. In the case of planktonic bacteria, where a bacterial count of colony forming units (cfu) per milliliter can be ascertained, typical dosage is expected to be in 0.0006 phage(pfu) per bacteria cfu to 0.1 phage(pfu) per bacteria cfu, such as 0.0006 phage(pfu) per bacteria cfu to 0.06 phage(pfu) per bacteria cfu, or 0.006 phage(pfu) per bacteria cfu to 0.06 phage(pfu) per bacteria cfu. For planktonic bacteria, any range between 0.0006 and 0.1 phage(pfu) per bacteria cfu is envisioned by the present invention. If the concentration of planktonic bacteria is not known, then the addition could be done on a phage(pfu)/ml basis. Regarding sessile bacteria (or planktonic without knowledge or use of cfu) any range between 1×10³ and 1×10¹² pfu/ml relative to the water in the cooling tower is envisioned by the present disclosure, including about 5×10³ to 1×10¹¹, and 1×10³ to 1×10¹⁰, and 1×10⁵ to 1×10⁸, and any ranges within those ranges. Plaque forming units are well known in the field of virology and no further explanation is needed in this regard. This amount of phage in the water should result in effective reduction of undesired bacteria.

Another option is to use phage inside liposomes, which cold result in the liposomes adhering to the walls of the cooling towers, and stay there to protect against future bacteria for some period of time. Also, the liposomes can protect the phage from the environment in the cooling tower, such as chlorine, and can also help penetrate biofilms.

Liposomes, or lipid bodies, are systems in which lipids are added to an aqueous buffer to form vesicles, structures that enclose a volume. More specifically, liposomes are microscopic vesicles, most commonly composed of phospholipids and water. In one embodiment, the lipid may be a phospholipid, lethicin, phosphatidyl choline, glycolipid, triglyceride, sterol, fatty acid, sphingolipid, or combinations thereof.

Liposomes can be composed of naturally-derived phospholipids with mixed lipid chains (like egg phosphatidylethanolamine) or other surfactants. Examples of the phospholipids can include phosphatidylcholines (e.g., lecithin), phosphatydic acids, phosphatidylethanolamines (e.g., cephalin), phosphatidyl cerines, ceramide phosphrylcholines, ceramide phosphorylglycerols, etc.

When properly mixed, the phospholipids arrange themselves into a bilayer or multilayers, very similar to a cell membrane, surrounding an aqueous volume core. Liposomes can be produced to carry various compounds or chemicals within the aqueous core, or the desired compounds can be formulated in a suitable carrier to enter the lipid layer(s). Liposomes can be produced in various sizes and may be manufactured in submicron to multiple micron diameters. The liposomes may be manufactured by several known processes. Such processes include, but are not limited to, controlled evaporation, extrusion (e.g., pressure extrusion of a phage through a porous membrane into the lipid body or vice-versa, or pressure extrusion of a phage through a porous membrane into the lipid body), injection, sonication, microfluid processors and rotor-stator mixers. Information on liposome formation and encapsulation of other materials can be found at, for example, at U.S. Pat. No. 7,824,557 and U.S. Patent Application Publication No. 2011/0052655, which are both incorporated by reference herein in their entireties. The method of incorporating phage into liposomes would be the same as the method of incorporating biocide as disclosed in U.S. Pat. No. 7,824,557 and U.S. Patent Application Publication No. 2011/0052655. Liposomes can be produced in diameters ranging from about 10 nanometers to greater than about 15 micrometers. When produced in sizes from about 100 nanometers to about 2 micrometer sizes the liposomes are very similar in size and composition to most microbial cells. The phage composition-containing liposomes are preferably produced in sizes that mimic bacterial cells, from about 0.05 to about 15 micrometers, or alternately, about 0.1 to 10.0 micrometers. However, other sizes are also appropriate. In one embodiment, the liposomes have a size of from about 0.01 micron to about 100 microns. In another embodiment, the liposomes may be from about 0.01 micron to about 50 microns. In another embodiment, the liposomes have a size of from about 0.01 micron to about 20 microns. In another embodiment, the liposome has a size of from about 0.05 micron to about 15 microns. In another embodiment, the liposomes have a size of from about 0.1 micron to about 10 microns. In another embodiment, the liposomes have a size of from about 0.1 micron to about 2 microns. The size of the liposomes is measured directly by microscopic techniques.

In one embodiment, lipids are added to an aqueous buffer solution containing phage and mixed to form a liposome vesicle containing phage. The lipids can arrange themselves into a bilayer or multilayer microscopic vesicle, very similar to a cell membrane, surrounding an aqueous volume core containing phage. In one embodiment, the phage is within the aqueous core of the liposome. In another embodiment, the phage may be injected into the liposome and carried in one of the lipid layers.

The liposomes may be the encapsulating bodies containing the phage, or such phage may themselves be further encapsulated, e.g., by a thin shell of protective material. In the latter case, the shell may, for example, be compounded to provide a further, temporary protective cover for the liposome, such as a degradable skin, that enhances the lifetime of the liposome in the water system yet dissolves, decays or otherwise breaks down after a certain time, or under certain conditions, releasing the liposomes which may then act on the target organisms.

If liposomes are utilized in the water to house at least some of the phage, the concentration of phage in the aqueous solution in the cooling tower could be somewhat lower because of the increase in effectiveness against biofilms, and can be from to 1×10² to 1×10¹⁰ pfu/ml (plaque forming units per milliliter of water), and preferably in an amount of from 1×10⁶ to 1×10¹⁰ pfu/ml. In the case of planktonic bacteria, where a bacterial count of colony forming units (cfu) per milliliter can be ascertained, typical dosage is expected to be in 0.0006 phage pfu per bacteria cfu to 0.1 phage pfu per bacteria cfu, such as 0.0006 phage pfu per bacteria cfu to 0.06 phage pfu per bacteria cfu, or 0.006 phage pfu per bacteria cfu to 0.06 phage pfu per bacteria cfu. For planktonic bacteria, any range between 0.0006 and 0.1 phage pfu per bacteria cfu is envisioned by the present invention. Regarding sessile bacteria (or planktonic without knowledge or use of the cfu) any range between 1×10² and 1×10¹⁰ pfu/ml relative to the water or aqueous medium in the cooling tower is envisioned by the present disclosure, including about 5×10² to 1×10¹⁰, and 1×10³ to 1×10¹⁰, and 1×10⁵ to 1×10⁸, and any ranges within those ranges. The presence of the liposome, as stated above, makes it possible for the concentrations to be somewhat lower than in a solution without liposomes, namely, 1×102 to 1×10¹⁰ pfu/ml of aqueous solution in the cooling tower.

Any range within 1×10² to 1×10¹⁰ pfu/ml is envisioned in the present invention, including 5×10² to 1×10⁹pfu/ml, 1×10² to 1 x 10′ pfu/ml, and 1×10³ to 1×10⁶ pfu/ml, and any range within these ranges.Liposomes have better biofilm penetration capabilities due to the hydrophillicity of the outer layer of the liposome, and also the increased protection of the phage by the liposome, as explained below. It is noted that the solution including phage and liposomes will likely include the phage inside and outside the liposomes, but the phage which is located inside the liposomes will be better protected.

Some of the environments inside the cooing towers may be inhospitable to phage, so the presence of liposomes in the water would protect the phage inside the liposomes against potentially hazardous environments to which the phage would otherwise be exposed to. For example, in the event that a cooling tower has chlorine in a concentration that could be detrimental to phage, lecithin liposomes would provide some protection to the phage against chlorine.

In the event that a time-release of the phage is desired in order to reduce the frequency of phage application, the phage could be microencapsulated or even macroencapsulated into particles of phage-containing solid or semi-solid materials. These materials would slowly hydrolyze and release the phage over a period of time into the water. The concentrations of phage desired in these solid or semi-solid materials would vary depending on the amount of these solid or semi-solid materials in water, and on the speed of hydrolysis. Ultimately, the desired concentration of phage in the water would be the same as disclosed above, so the concentration of phage in the solid or semi-solid materials would be appropriate to result in such phage concentration in the water based upon the dissolution rate of such solid or semi-solid material.

The concentrations of phage described above are what is to be obtained based upon the addition of phage into the system. However, if the phage that is added reproduces and is effective against the bacteria, the concentrations of phage that are added can then be reduced accordingly. One example to monitor effectiveness is to create an offshoot flow from the cooling tower (and/or heat exchanger) that would take flowing aqueous medium from the cooling tower to a different location and back to the cooling tower. Such flowing water cold be periodically monitored for the presence of phage and bacteria. Also, coupons (potentially a number of them) made of steel or copper can be included in the offshoot to replicate the environment inside the cooling tower, and can be examined periodically to detect the growth of bacteria. In fact, such offshoot could also be utilized to obtain aqueous samples which contain target bacteria, and the coupons could also provide samples of target bacteria that can be utilized to obtain phage specific to those bacteria.

Phage can be micro-encapsulated, with or without the use of liposomes, to provide further protection to the phage and/or to result in a time-release environment. Micro-encapsulation is a process in which tiny agglomerations of phage are surrounded by a coating to give small capsules. In practice, it will not be just phage that will be encapsulated. Rather, it will be phage in some kind of carrier, such as water, an oil-based solvent, or even a cross-linked saccharide or polymer which will hydrolyze or dissolve in aqueous solutions. The size of these microcapsules can be from about 1 micrometer to about 5 millimeters. Techniques to manufacture microcapsules include the air-suspension coating, where phage-containing droplets or particles are suspended in an upward-moving air stream and exposed to the coating material. Alternatively, the phage can be mixed with a liquid material which contains crosslinker, then separated into particles, and then crosslinked to increase viscosity and reduce tackiness. Hydroxypropylmethylcellulose can be such material. Another way to make the microcapsules is to take phage-containing liquids and put them through a rotating extrusion head containing concentric nozzles. In this process, a jet of core liquid is surrounded by a sheath of wall solution or melt. As the jet moves through the air it breaks, owing to Rayleigh instability, into droplets of core, each coated with the wall solution. While the droplets are in flight, a molten wall may be hardened or a solvent may be evaporated from the wall solution. In spray-drying, the phage is suspended in a polymer solution and becomes trapped in the dried particle when the particle dries. Alternatively, a crosslinking reaction may be what traps the phage in the material.

It is noted that the encapsulant may encapsulate the phage in a carrier, or it can both encapsulate the phage and is also the carrier. Thus, phage in water can be encapsulated by polymer. Alternatively, phage in the polymer itself forms the microcapsule. Materials that can be used for the encapsulation include cellulose acetate, cellulose acetate butyrate, cellulose acetate phthalate, dextrins, ethyl cellulose, ethylene vinyl acetate, fats, fatty acids, gelatin, glycerides, vegetable gums, hydroxyl propyl cellulose, hydroxypropyl methyl cellulose, hydroxypropyl methyl cellulose phthalate, maltodextrins, methyl cellulose, polylactides, polyethylene glycol, polyvinyl acetate, polyvinyl alcohol, proteins, and starches. The molecular weight/crosslinking of the material can be adjusted for the particular desired hydrolysis resistance and subsequent release of phage. The thickness of the encapsulant can determine the rate of release of the phage as well.

Other materials that can be utilized to form the encapsulant, with crosslinking as necessary, are lecithin, gums, gels, biodegradable or non-biodegradable polymers, such as polylactic acid or polystyrene, organic polymers, combinations of lecithin and organically functionalized lecithin where the functionalization can either be polymer chains, peptides, proteins, lipids, cholesterols or bio receptors. The material may also be multi-block polymers containing hydrophobic and hydrophilic blocks, self-assembled donor:acceptor moieties and micelles, inorganic spheres, rods, cages or particles.

In one embodiment, the capsules may be from about 0.01 micron to about 100 microns. In another embodiment, the capsules have a size of from about 0.01 micron to about 50 microns. In another embodiment, the capsules have sizes from about 0.01 micron to about 20 microns. In another embodiment, the capsules have a size of from about 0.05 micron to about 15 microns. In another embodiment, the capsules have a size of from about 0.1 micron to about 10 microns. In another embodiment, the capsules have a size of about 0.25 micron to about 2 microns. The size of the capsules is measured directly by microscopic techniques.

In cooling towers, corrosion and heat transfer issues as a result of biofilms are not the only challenge. Other challenges include reduction of other kinds of fouling, such as particulate matter such as iron, aluminum, and clay. Thus, the composition may additionally comprise carboxylic acid homo/copolymers for use as calcium phosphate inhibitors and dispersant of particulate matter like iron, aluminum, clay which do not adversely affect the phage's ability to adequately attack the target bacteria. For example, water-soluble or water-dispersible copolymers of ethyleneically unsaturated monomers with sulfate, phosphage, phosphate, or carboxylic terminated polyalylene oxide allyl ethers can be utilized simultaneously to the phage in concentrations of about 0.1 to 500 parts per million relative to the water, preferably 1 to 100 parts per million relative to the water, or any range within these ranges. A detailed explanation of these polymers and processes of making them is found at, for example, in U.S. Pat. Nos. 6641754B2, 7094852B2, and 6444747B1, all three of which are incorporated by reference herein in their entireties.

Other potential compounds that can be used in conjunction with the phage are phosphate and phosphonate mild steel corrosion inhibitors.

Other potential compounds that can be used in conjunction with the phage are azoles and substituted azoles as copper corrosion inhibitors in a concentration of 0.5 to 10 parts per million, or any range within this range, which should not be high enough to interfere with the phage's goal of attacking biofilms. For example, halo-benzotriazoles such as chloro-tolytriazole and bromo-tolytriazole can be used. Additional information on these chemicals can be found at, for example, U.S. Pat. Nos. 5,772,919, 5,773,627, and 5,863,464, all three of which are incorporated by reference herein in their entireties.

The phage can also be utilized in conjunction with biodispersants, as well as additives for preventing quality deterioration, such as binders, emulsifiers and preservatives.

For bacteriophages to be effective, they need to be compatible (i.e. unaffected by the presence of) with other water treatment chemicals present in the cooling water environment, such as commonly used oxidizing agents (bleach, chlorine dioxide, hydrogen peroxide, ozone) and chemical agents of inherent unselective toxicity (Kathon). The use of liposomes or other encapsulants, as disclosed above, can address this issue.

An alternative to continuous feed under these stressful conditions would be to shot feed phages and oxidizing biocides in an alternate manner. This strategy is not limited to oxidizing treatment only but to any other chemical treatment that phages may be incompatible with in a cooling water environment. The shot feed treatment would be alternated in such a way that 50-100%, preferably close to 100% of the oxidizing agent has been removed before the phage is added to the system. This way, efficiency can be increased while protecting the phage in certain adverse environments.

It is also possible, when utilizing a combination of phage (whether in liposomes or other encapsulants, or not) and other biocides, to encapsulate the biocides in a liposome.

Pipeline Corrosion

Hydrocarbon pipelines often include sufficient moisture to permit bacterial growth, resulting in microbiological induced corrosion (MIC), such as that caused by sulfate reducing bacteria (SRB). The MIC is often caused by a biofilms of aerobic bacteria which protects SRB which is anaerobic and in direct contact with the pipeline's inner surface. This creates acid conditions and other metal-corroding conditions, which will result in localized corrosion and eventual failure of the pipe.

The corrosion of iron-containing components can be especially detrimental. Oxidation of iron to iron(II) and reduction of sulfate to sulfide ion with resulting precipitation of iron sulfide and generation of corrosive hydrogen ions in situ may take place via the sulfate reducing bacteria. The corrosion of iron by sulfate reducing bacteria is rapid and, unlike ordinary rusting, it is not self-limiting. Tubercles produced by Desulfovibrio consist of an outer shell of red ferric oxide mixed with black magnetic iron oxide, containing a soft, black center of ferrous sulfide. A technical explanation follows in view of chemical Equations (I)-(VI) below.

8H₂O→8H³⁰+8OH⁻ (I)

4Fe+8H³⁰→4Fe⁺²+8H (II)

SO₄⁻²+8H→H₂S+2H₂O+2OH⁻ (III)

Fe⁺²°8H→H₂S+2H₂O+2OH⁻ (IV)

3Fe⁺²+6OH⁻→3Fe(OH)₂ (V)

4Fe+SO₄⁻²+4H₂O→FeS+3Fe(OH)₂OH³¹ (VI)

Equations I and II represent the anodic dissolution of iron. Equation III, the essential step, represents cathodic depolarization through a hydrogenase enzyme, by which sulfate-reducing bacteria reduces sulfates to hydrogen sulfide. This organism thus participates directly in the corrosion process by consuming the monatomic layer of adsorbed elemental hydrogen atoms produced at cathodes. Equations IV and V represent the formation of corrosion products. Equation VI is the net reaction of this corrosion process.

In the case of pipelines, the use of bacteriophages and/or biocides will help eliminate the bacteria present. Even if there are deposits or current flows inside the pipelines that would make it difficult for biocides to enter and kill the bacteria, the use of phages can be of great help. Unlike biocides, which are “used up” when they enter a bacteria, phages are actually augmented when they enter a bacteria. Thus, even if a small amount of phages reach a bacterial colony, they will then reproduce inside the bacteria and attack other members of the colony. The phage(whether by itself or enclosed in a liposome or other encapsulants) would be added to the flowing stream or oil in tankage.

In one aspect of the present invention, a bacteriophage is provided which has a specific bactericidal activity against one or more sulfate reducing bacteria selected from the group consisting of Desulfovibrio and other sulfate reducing bacteria, including, without limitation, Desulfovibrio vulgaris, Desulfovibrio desulfuricans, and Desulfovibrio postgatei, as well as Caulobacteriaceae such as C. Gallionella, and Siderophacus, and Thiobacilli, such as T. thiooxidans and T. denitrificans. Of particular concern is T. ferrooxidans. Hydrocarbon pipelines include mostly hydrocarbons, but also contain water, and this water would be partially dissolved in the hydrocarbons, but also as pockets in the pipelines. It is in these pockets of water that most of the corrosion will occur. Such water will contain metals, such as Cu, Fe, and V. The bacteria that can be addressed in the present invention includes, but is not limited to: Acidithiobaccillus bacteria such as Acidithiobacillus thiooxidans; Ferrobacillus, such as Ferrobacillus ferrooxidans; Thiobacilli, such as Thiobacillus thiooxidans, Thiobacillus thioparus, Thiobacillus concretivorous, Thiobacillus denitrificans, and T ferrooxidans; Desulfovibrionaceae such as Desulfovibrio salixigens, Desulfovibrio vulgaris, Desulfovibrio desulfuricans, Desulfovibrio africanus, and Desulfubriopostgatei; Desulfotomaculum such as Desulfotomaculum orientis and Desulfotomaculum nigrificans; Caulobacteriaceae such as C. Gallionella; and Siderophacus.

One way to address the growth of bacteria in hydrocarbon pipelines (“pipelines”) is to expose such bacteria to phage that is specific to the bacteria in the pipeline (whether present in the water or deposited on the pipeline's walls as biofilm). The bacteria from pipelines can be cultured from samples of hydrocarbon or water or bacteria from the pipe, or from samples of the walls of the pipeline. The phage itself can be obtained from the surrounding areas. The source of the bacteria may be the source of the hydrocarbons (e.g., the wells or other subterranean structures there the hydrocarbons, such as crude oil, are obtained). This would also be a logical place to obtain soil or other samples to find phage which is specific to the target bacteria. In the case of T. ferrooxidans, and other well-known bacteria, the phage may be available from commercial sources.

Biocides could also be utilized in the pipeline to assist the phage in killing the bacteria. For example, if the phage kills one or more species of bacteria, and the biocide kills all or most of the rest of the problematic species of bacteria, this will significantly reduce the production of acid underneath biofilms and also reduce the corrosion of the metal on which the biofilms are located. The use of biocides would be reduced in combination with phage than by themselves. In one embodiment, biocides can include non-oxidizing, oxidizing, biodispersant, and molluscicide antimicrobial compounds and mixtures thereof. In another embodiment, suitable biocides include, but are not limited to guanidine or biguanidine salts; quaternary ammonium salts; phosphonium salts; 2-bromo-2-nitropropane-1,3-diol; 5-chloro-2-methyl-4-isothiazolin-3-one/2-methyl-4-isothiazolin-3-one; n-alkyl-dimethylbenzylammonium chloride; 2,2-dibromo-3-nitrilopropionamidemethylene-bis(thiocyanate); dodecylguanidine hydrochloride; glutaraldehyde; 2-(tert-butylamino)-4-chloro-6-(ethylamino)-s-triazine; beta-bromonitrostyrene; tributyltinoxide; n-tributyltetradecyl phosphonium chloride; tetrahydroxymethyl phosphonium chloride; 4,5-dichloro-1,2-dithiol-3-one; sodium dimethyldithiocarbamate; disodium ethylenebisdithiocarbamate; Bis(trichloromethyl) sulfone; 3,5-dimethyl-tetrahydro-2H-1,3,5-thiadiazine-2-thione; 1,2-benzisothiazolin-3-one; decylthioethylamine hydrochloride; copper sulfate; silver nitrate; bromochlorodimethylhydantoin; sodium bromide; dichlorodimethylhydantoin; sodium hypochlorite; hydrogen peroxide; chlorine dioxide; sodium chlorite; bromine chloride; peracetic acid and precursors; sodium trichloroisocyanurate; sodium trichloroisocyanurate; ethylene oxide/propylene oxide copolymers; trichlorohexanoic acid; polysiloxanes; carbosilanes; polyethyleneimine; dibromo, dicyano butane; and combinations thereof. The amount of biocide utilized can be 0.001 ppm to about 20 ppm relative to pipeline fluid, and any range between 0.001 ppm to about 20 ppm relative to pipeline fluid is envisioned by the present disclosure, including about 0.1 ppm to 15 ppm, 0.5 ppm to 10 ppm, and 3 ppm to about 8 ppm, and any ranges within those ranges. In practice, oxidizing biocides are less preferred due to the additional corrosion that they may cause to pipelines. The amount of biocides should be lower than used normally due to the fact that phage is being used to destroy major species of bacteria, such as the more problematic or more biocide resistant.

The amount of phage that could be used in the pipeline itself would be from to 1×10³ to 1×10¹² pfu/ml (plaque forming units per milliliter of fluid in the pipeline), and preferably in an amount of from 1×10⁶ to 1×10¹⁰ pfu/ml. In the case of planktonic bacteria, where a bacterial count of colony forming units (cfu) per milliliter can be ascertained, typical dosage is expected to be in 0.0006 phage pfu per bacteria cfu to 0.1 phage pfu per bacteria cfu, such as 0.0006 phage pfu per bacteria cfu to 0.06 phage pfu per bacteria cfu, or 0.006 phage pfu per bacteria cfu to 0.06 phage pfu per bacteria cfu. For planktonic bacteria, any range between 0.0006 and 0.1 phage pfu per bacteria cfu is envisioned by the present invention. Regarding sessile bacteria (or planktonic without knowledge or use of the cfu) any range between 1×10³ and 1×10¹² pfu/ml relative to the fluid in the pipeline is envisioned by the present disclosure, including about 5×10³ to 1×10¹¹, 1×10³ to 1×10¹⁰, and 1×10⁵ to 1×10⁸, and any ranges within those ranges. Plaque forming units are well known in the field of virology and no further explanation is needed in this regard.

Another option is to use phage inside liposomes, which cold result in the liposomes adhering to the walls of the pipelines, and stay there to protect against future bacteria for some period of time. Also, the liposomes can protect the phage from the environment in the pipelines, such as metals present in the fluid, and can also help penetrate biofilms. Morover, the hydrophillicity of the liposomes would help the liposomes be present in the pockets of aqueous fluid in the pipeline, as opposed to the hydrocarbon portion. This would help direct the phage where the bacteria and corrosion are more likely to be located.

Liposomes, or lipid bodies, are systems in which lipids are added to an aqueous buffer to form vesicles, structures that enclose a volume. More specifically, liposomes are microscopic vesicles, most commonly composed of phospholipids and water. In one embodiment, the lipid may be a phospholipid, lethicin, phosphatidyl choline, glycolipid, triglyceride, sterol, fatty acid, sphingolipid, or combinations thereof.

Liposomes can be composed of naturally-derived phospholipids with mixed lipid chains (like egg phosphatidylethanolamine) or other surfactants. Examples of the phospholipids can include phosphatidylcholines (e.g., lecithin), phosphatydic acids, phosphatidylethanolamines (e.g., cephalin), phosphatidyl cerines, ceramide phosphrylcholines, ceramide phosphorylglycerols, etc.

When properly mixed, the phospholipids arrange themselves into a bilayer or multilayers, very similar to a cell membrane, surrounding an aqueous volume core. Liposomes can be produced to carry various compounds or chemicals within the aqueous core, or the desired compounds can be formulated in a suitable carrier to enter the lipid layer(s). Liposomes can be produced in various sizes and may be manufactured in submicron to multiple micron diameters. The liposomes may be manufactured by several known processes. Such processes include, but are not limited to, controlled evaporation, extrusion (e.g., pressure extrusion of a phage through a porous membrane into the lipid body or vice-versa, or pressure extrusion of a phage through a porous membrane into the lipid body), injection, sonication, microfluid processors and rotor-stator mixers. Information on liposome formation and encapsulation of other materials can be found at, for example, at U.S. Pat. No. 7,824,557 and U.S. Patent Application Publication No. 2011/0052655, which are both incorporated by reference herein in their entireties. The method of incorporating phage into liposomes would be the same as the method of incorporating biocide as disclosed in U.S. Patent No. 7,824,557 and U.S. Patent Application Publication No. 2011/0052655.

Liposomes can be produced in diameters ranging from about 10 nanometers to greater than about 15 micrometers. When produced in sizes from about 100 nanometers to about 2 micrometer sizes the liposomes are very similar in size and composition to most microbial cells. The phage composition-containing liposomes are preferably produced in sizes that mimic bacterial cells, from about 0.05 to about 15 micrometers, or alternately, about 0.1 to 10.0 micrometers. However, other sizes are also appropriate. In one embodiment, the liposomes have a size of from about 0.01 micron to about 100 microns. In another embodiment, the liposomes may be from about 0.01 micron to about 50 microns. In another embodiment, the liposomes have a size of from about 0.01 micron to about 20 microns. In another embodiment, the liposomes have a size of from about 0.05 micron to about 15 microns. In another embodiment, the liposomes have a size of from about 0.1 micron to about 10 microns. In another embodiment, the liposomes have a size of from about 0.1 micron to about 2 microns. The size of the liposomes is measured directly by microscopic techniques.

In one embodiment, lipids are added to an aqueous buffer solution containing phage (one or more) and mixed to form a liposome vesicle containing phage. The lipids can arrange themselves into a bilayer or multilayer microscopic vesicle, very similar to a cell membrane, surrounding an aqueous volume core containing phage. In one embodiment, the phage is within the aqueous core of the liposome. In another embodiment, the phage may be injected into the liposome and carried in one of the lipid layers.

The liposomes may be the encapsulating bodies containing the phage, or such phage may themselves be further encapsulated, e.g., by a thin shell of protective material. In the latter case, the shell may, for example, be compounded to provide a further, temporary protective cover for the liposome, such as a degradable skin, that enhances the lifetime of the liposome in the water system yet dissolves, decays or otherwise breaks down after a certain time, or under certain conditions, releasing the liposomes which may then act on the target organisms.

If liposomes are utilized in the water to house at least some of the phage, the concentration of phage in the aqueous solution in the pipelines could be less than if no liposomes are used due to the protection and increased biofilm penetration that liposomes provide to phage, and the phage could be used from to 1×10² to 1×10¹⁰ pfu/ml (plaque forming units per milliliter of fluid in the pipeline), and preferably in an amount of from 1×10⁶ to 1×10¹⁰ pfu/ml. In the case of planktonic bacteria, where a bacterial count of colony forming units (cfu) per milliliter can be ascertained, typical dosage is expected to be in 0.0006 phage pfu per bacteria cfu to 0.1 phage pfu per bacteria cfu, such as 0.0006 phage pfu per bacteria cfu to 0.06 phage pfu per bacteria cfu, or 0.006 phage pfu per bacteria cfu to 0.06 phage pfu per bacteria cfu. For planktonic bacteria, any range between 0.0006 and 0.1 phage pfu per bacteria cfu is envisioned by the present invention. Regarding sessile bacteria, or planktonic without knowledge or use of the cfu, any range between 1×10² and 1×10¹⁰ pfu/ml relative to the pipeline fluid is envisioned by the present disclosure, including about 5×10² to 1×10¹⁰, and 1×10³ to 1×10⁹, and 1×10⁵ to 1×10⁸. These ranges reflect that the presence of the liposome will permit for the concentrations to be somewhat lower than in a solution without liposomes, including 1×10² to 1×10¹⁰ pfu/ml of fluid in the pipeline. Any range within 1×102 to 1×10¹⁰ pfu/ml is envisioned in the present invention, including 5×10² to 1×10⁹ pfu/ml, 1×10² to 1×10⁷ pfu/ml, and 1×10³ to 1×10⁶ pfu/ml, and any range within these ranges. This is the case since the liposomes have better biofilm penetration capabilities due to the hydrophillicity of the outer layer of the liposome, and also the increased protection of the phage by the liposome, as explained below. It is noted that the solution including phage and liposomes will likely include the phage inside and outside the liposomes, but the phage which is located inside the liposomes will be better protected.

Some of the environments inside the pipelines may be inhospitable to phage, so the presence of liposomes in the pipeline fluid would protect the phage inside the liposomes against potentially hazardous environments to which the phage would otherwise be exposed to, such as various metals.

In the event that a time-release of the phage is desired in order to reduce the frequency of phage application, the phage could be microencapsulated or even macroencapsulated into particles of phage-containing solid or semi-solid materials. These materials would slowly hydrolyze and release the phage over a period of time into the pipeline fluid. The concentrations of phage desired in these solid or semi-solid materials would vary depending on the amount of these solid or semi-solid materials in the pipeline fluid, and on the speed of hydrolysis. Ultimately, the desired concentration of phage in the pipeline fluid be the same as disclosed above, so the concentration of phage in the solid or semi-solid materials would be appropriate to result in such phage concentration in the pipeline fluid based upon the dissolution rate of such solid or semi-solid material.

The concentrations of phage described above are what is to be obtained based upon the addition of phage into the system. However, if the phage that is added reproduces and is effective against the bacteria, the concentrations of phage that are added can then be reduced accordingly. One example to test efficacy is to create an offshoot flow from the pipeline that would take flowing pipeline fluid from the pipeline to a different location and back into the pipeline. Such flowing pipeline fluid could be periodically monitored for the presence of phage and bacteria. Also, coupons (potentially a number of them) made of steel or copper can be included in the offshoot to replicate the environment inside the pipeline, and can be examined periodically to detect the growth of bacteria. In fact, such offshoot could also be utilized to obtain liquid samples which contain target bacteria, and the coupons could also provide samples of target bacteria that can be utilized to obtain phage specific to those bacteria.

It is also possible, when utilizing a combination of phage (whether in liposomes or other encapsulants, or not) and other biocides, to encapsulate the biocides in a liposome.

Phage can be micro-encapsulated, with or without the use of liposomes, to provide further protection to the phage and/or to result in a time-release environment. Micro-encapsulation is a process in which tiny agglomerations of phage are surrounded by a coating to give small capsules. In practice, it will not be just phage that will be encapsulated. Rather, it will be phage in some kind of carrier, such as water, an oil-based solvent, or even a cross-linked saccharide or polymer which will hydrolyze or dissolve in the pipeline fluid, especially the water-based pockets. The size of these microcapsules can be from about 1 micrometer to about 5 millimeters. Techniques to manufacture microcapsules include the air-suspension coating, where phage-containing droplets or particles are suspended in an upward-moving air stream and exposed to the coating material. Alternatively, the phage can be mixed with a liquid material which contains crosslinker, then separated into particles, and then crosslinked to increase viscosity and reduce tackiness. Hydroxypropylmethylcellulose can be such material. Another way to make the microcapsules is to take a phage-containing liquids and put them through a rotating extrusion head containing concentric nozzles. In this process, a jet of core liquid is surrounded by a sheath of wall solution or melt. As the jet moves through the air it breaks, owing to Rayleigh instability, into droplets of core, each coated with the wall solution. While the droplets are in flight, a molten wall may be hardened or a solvent may be evaporated from the wall solution. In spray-drying, the phage is suspended in a polymer solution and becomes trapped in the dried particle when the particle dries. Alternatively, a crosslinking reaction may be what traps the phage in the material.

It is noted that the encapsulant may encapsulate the phage in a carrier, or it can both encapsulate the phage and is also the carrier. Thus, phage in the pipeline fluid can be encapsulated by polymer. Alternatively, phage in the polymer itself forms the microcapsule. Materials that can be used for the encapsulation include cellulose acetate, cellulose acetate butyrate, cellulose acetate phthalate, dextrins, ethyl cellulose, ethylene vinyl acetate, fats, fatty acids, gelatin, glycerides, vegetable gums, hydroxyl propyl cellulose, hydroxypropyl methyl cellulose, hydroxypropyl methyl cellulose phthalate, maltodextrins, methyl cellulose, polylactides, polyethylene glycol, polyvinyl acetate, polyvinyl alcohol, proteins, and starches. The molecular weight/crosslinking of the material can be adjusted for the particular desired hydrolysis resistance and subsequent release of phage. The thickness of the encapsulant can determine the rate of release of the phage as well.

Other materials that can be utilized to form the encapsulant, with crosslinking as necessary, are lecithin, gums, gels, biodegradable or non-biodegradable polymers, such as polylactic acid or polystyrene, organic polymers, combinations of lecithin and organically functionalized lecithin where the functionalization can either be polymer chains, peptides, proteins, lipids, cholesterols or bio receptors. The material may also be multi-block polymers containing hydrophobic and hydrophilic blocks, self-assembled donor:acceptor moieties and micelles, inorganic spheres, rods, cages or particles.

In one embodiment, the capsules may be from about 0.01 micron to about 100 microns. In another embodiment, the capsules have a size of from about 0.01 micron to about 50 microns. In another embodiment, the capsules have sizes from about 0.01 micron to about 20 microns. In another embodiment, the capsules have a size of from about 0.05 micron to about 15 microns. In another embodiment, the capsules have a size of from about 0.1 micron to about 10 microns. In another embodiment, the capsules have a size of about 0.25 micron to about 2 microns. The size of the capsules is measured directly by microscopic techniques.

For bacteriophages to be effective, they need to be compatible (i.e. unaffected by the presence of) with other elements present in the pipeline fluid, The use of liposomes or other encapsulants, as disclosed above, can address this issue.

An alternative to continuous feed under these stressful conditions would be to shot feed phages and oxidizing biocides in an alternate manner. This strategy is not limited to oxidizing treatment only but to any other chemical treatment that phages may be incompatible with in a pipeline environment. The shot feed treatment would be alternated in such a way that 50-100%, preferably close to 100% of the oxidizing agent has been removed before the phage is added to the system. This way, efficiency can be increased while protecting the phage in certain adverse environments.

Various corrosion inhibitors can be used to combat microbial corrosion. Formulae based on benzalkonium chloride are common in the oilfield industry, can be used in a range from 0.5 ppm to 25 ppm relative to the pipeline fluid. Any range within the range of 0.5 ppm and 25 ppm is envisioned by the present invention, including 1 ppm to 15 ppm, 3 ppm to 10 ppm, and 5ppm to 8 ppm. The presence of liposomes or other encapsulants can protect the phage against these corrosion inhibitors.

Wastewater Treatment

Wastewater treatment involves adding activated sludge downstream of a wastewater treatment plant in order to remove organic pollutants. Thus, after water is treated in a waste treatment facility, many organic pollutants are present which can be “digested” by bacteria. Thus, the activated sludge is added to the treated water in a tank/container to treat the effluent from the wastewater treatment facility.

However, sometimes a bacteria in the tank/container (whether originating from the activated sludge, the wastewater itself, or the surrounding environment), will dominate and grow very rapidly. Such rapid growth can result in a filamentous-shaped bacterial growth. Filaments can form up to 20-30% of bacterial population, and they float. This filamentous growth results in what is known as bulking sludge.

Bacteriophage can be utilized for bulking sludge control, which is an important aspect in wastewater treatment. A bulking sludge is one that has poor settling characteristics (since it floats) and poor compactability (due to the filamentous shape of the bacteria). A major cause of bulking sludge, as explained above, is the growth of filamentous organisms or organisms that can grow in a filamentous form under adverse conditions. The presence of filamentous organisms causes the biological flocs to be bulky and loosely packed. This results in poor settleability, poor dewaterability, and large volume carryover of bacterial mass in the effluent from the sedimentation tank. Causes of sludge bulking are related to the physical and chemical characteristics of the wastewater, treatment plant design limitations, and/or plant operations. Wastewater characteristics that can affect sludge bulking include fluctuations in flow and strength, pH, temperature, age, nutrient content and nature of the waste components, while design limitations include air supply capacity, clarifier design, return sludge pumping capacity limitations, short circuiting, or poor mixing.

The floating filaments stop dead bacteria from settling to the bottom of the tank to be discarded, and therefore remain in the tank. Also, once the filamentous bacteria are removed from the tank (whether from the top or bottom), it is difficult to compact them and remove the water, so there are disposal issues involved since the water-lade bacteria cannot just be dumped in a landfill.

Typically, chlorine treatments are used to kill all of the bacteria in a settling tank to remove the filamentous bacteria, and the tank is then reseeded. However, re-growth of bacteria takes 1-2 weeks, at which point the effluent of the water treatment facility cannot be adequately treated to remove the organic pollutants.

A profile of the organisms present is important to understand and control bulking, since more than 20 different morphological types of filamentous organisms have been found in activated sludge. These include a variety of filamentous bacteria, actinomycetes, and fungi. However, a main culprit that is often encountered is filamentous bacteria, including but not limited to, Sphaerotilus natans, Thiothrix nivea, Thiotrix flexilis, Thiotrix defluvii, and/or Thiotrix unzii.

In one aspect of the invention, therefore, a bacteriophage is provided in the effluent of the wastewater treatment facility having a specific bactericidal activity against one or more filamentous bacteria, including Sphaerotilus or Thiothrix. These filamentous bacteria growing in the tank can be easily obtained from the tank, as the growths are often visible to the naked eye due to their size. Soil samples form the surrounding areas, or samples of soil samples upstream of the wastewater treatment plant can be utilized to screen for the presence of phage that is specific to the target filamentous bacteria. Such phage can be selected and grown, as described above, and then applied to the tank.

The use of phage would attack the filamentous bacteria with high specificity rather than the other desirable bacteria, and destroy the filamentous bacteria without the need to wipe out the entire bacterial population in the tank. This will reduce the use of chlorine, the reseeding of the tank, and the wait of 1-2 weeks for the bacteria to re-grow.

The amount of phage to be utilized is 1×10¹ to 1×10⁸ pfu/ml of effluent (i.e., plaque forming units per millileter of aqueous fluid in the tank). The present invention envisions the use of any range within 1×10¹ to 1×10⁸ pfu/ml, including 5×10¹ to 1×10⁷ pfu/ml, 1×10² to 1×10⁷ pfu/ml, and 1×10³ to 1×10⁶ pfu/ml, and any range within these ranges. The phage can also be added by shot feeding at high concentrations in one large application once the filamentous growth has reached a critical mass (or close to it), or by a slower addition at a lower dosage over time to attack the early onset of bacteria.

The filamentous bacteria Sphaerotilus and/or Thiothrix often form large filamentous colonies in wastewater treatment plants. Once a phage is identified in which is effective in one wastewater treatment plant, such phage may also be effective in other wastewater treatment plants because of the frequency of formation of filamentous growths of the same bacteria in different wastewater treatment facilities.

When the phage is added, the phage can be added to the top and bottom of the tank (i.e., feed points would either be to the aeration tank or basin on the top or inline to the return waste activated sludge on the bottom), in order to more effectively attack the filamentous bacterial growth from two directions.

It is also possible for there to be some alkalinity in the effluent stream, which may be adverse to the phage. In such a situation, the phage can be included inside liposomes in order to protect them against the alkalinity. The liposomes can also help protect the phage to temperatures which can go as high as 90 to 110° F., in the event that such temperature is adverse to the phage. The liposomes can also help the phage therein penetrate the bacterial colony to be attacked.

In another aspect of the present invention, a composition is provided for the prevention or treatment of bulking sludge caused by one or more filamentous organisms such as Sphaerotilus or Thiothrix, or as otherwise described above, comprising the bacteriophage as an active ingredient. Preferably, the composition is used as a wastewater treatment agent.

According to some embodiments, the composition may comprise: Nutrients such as nitrogen and phosphorous, trace inorganic elements, including potassium, calcium, iron, copper, manganese, boron, magnesium, chloride, sodium, aluminum, zinc, selenium, and a wetting agent to improve delivery by facilitating attachment to the filaments, such as one or more surfactants chosen from the class of linear alcohol ethoxylates, EO-PO block copolymers, and sulfosuccinates. The potential surfactants can also be one or more of the following: anionic surfactants, such as alkyl sulfates (e.g., ammonium laurel sulfate, sodium lauryl sulfate), alkyl ether sulfates (e.g., sodium laureth sulfate, sodium myreth sulfate), phosphates (e.g., alkyl aryl ether phosphate and elkyl ether phosphate), carboxylates (e.g., sodium stearate, sodium lauroyl sarcosinate), as well as cationic surfactants, such as quarternary ammonium cations (e.g., cetyl trimethylammonium bromide, cetylpyridinium chloride, benzalkonium chloride, dimethyldioctadecylammonium chloride, dioctadecyldimentylammonium bromide), and nonionic surfactants such as fatty alcohols (cetyl alcohol, searyl alcohol, oleyl alcohol), and polyoxyethylene glycol ethers (e.g., octaethylene grlycol monododecyl ether, pentaethylene glycol monododecyl ether, decyl glucoside, lauryl glucoside, octyl glucoside, glyceryl laurate, polysorbates, rorbitan alkyl esters, and dodecyldimethylamine oxide). The surfactants would be utilized in an amount of 0.02% to 0.2% on a weight basis relative to the effluent from the wastewater treatment facility. The present invention envisions any range within 0.02% to 0.2%, such as 0.025% to 0.15%, and 0.05% to 0.1%, or any range within these ranges.

For bacteriophages to be effective, they need to be compatible (i.e. unaffected by the presence of) with other water treatment chemicals present in the wastewater environment, such as commonly used coagulants such as aluminum chlorohydrate, quaternized polyamines, polyDADMAC, and high molecular weight flocculants such as copolymers of AETAC/AM, METAC/AM. The use of liposomes, as described above, will help protect the phage against these water treatment chemicals. A description of the liposomes follows below.

Liposomes, or lipid bodies, are systems in which lipids are added to an aqueous buffer to form vesicles, structures that enclose a volume. More specifically, liposomes are microscopic vesicles, most commonly composed of phospholipids and water. In one embodiment, the lipid may be a phospholipid, lethicin, phosphatidyl choline, glycolipid, triglyceride, sterol, fatty acid, sphingolipid, or combinations thereof

Liposomes can be composed of naturally-derived phospholipids with mixed lipid chains (like egg phosphatidylethanolamine) or other surfactants. Examples of the phospholipids can include phosphatidylcholines (e.g., lecithin), phosphatydic acids, phosphatidylethanolamines (e.g., cephalin), phosphatidyl cerines, ceramide phosphrylcholines, ceramide phosphorylglycerols, etc.

When properly mixed, the phospholipids arrange themselves into a bilayer or multilayers, very similar to a cell membrane, surrounding an aqueous volume core. Liposomes can be produced to carry various compounds or chemicals within the aqueous core, or the desired compounds can be formulated in a suitable carrier to enter the lipid layer(s). Liposomes can be produced in various sizes and may be manufactured in submicron to multiple micron diameters. The liposomes may be manufactured by several known processes. Such processes include, but are not limited to, controlled evaporation, extrusion (e.g., pressure extrusion of a phage through a porous membrane into the lipid body or vice-versa, or pressure extrusion of a phage through a porous membrane into the lipid body), injection, sonication, microfluid processors and rotor-stator mixers. Information on liposome formation and encapsulation of other materials can be found at, for example, at U.S. Pat. No. 7,824,557 and U.S. Patent Application Publication No. 2011/0052655, which are both incorporated by reference herein in their entireties. The method of incorporating phage into liposomes would be the same as the method of incorporating biocide as disclosed in U.S. Pat. No. 7,824,557 and U.S. Patent Application Publication No. 2011/0052655. Liposomes can be produced in diameters ranging from about 10 nanometers to greater than about 15 micrometers. When produced in sizes from about 100 nanometers to about 2 micrometer sizes the liposomes are very similar in size and composition to most microbial cells. The phage composition-containing liposomes are preferably produced in sizes that mimic bacterial cells, from about 0.05 to about 15 micrometers, or alternately, about 0.1 to 10.0 micrometers. However, other sizes are also appropriate. In one embodiment, the liposomes have a size of from about 0.01 micron to about 100 microns. In another embodiment, the liposomes may be from about 0.01 micron to about 50 microns. In another embodiment, the liposomes have a size of from about 0.01 micron to about 20 microns. In another embodiment, the liposome has a size of from about 0.05 micron to about 15 microns. In another embodiment, the liposomes have a size of from about 0.1 micron to about 10 microns. In another embodiment, the liposomes have a size of from about 0.1 micron to about 2 microns. The size of the liposomes is measured directly by microscopic techniques.

In one embodiment, lipids are added to an aqueous buffer solution containing phage and mixed to form a liposome vesicle containing phage. The lipids can arrange themselves into a bilayer or multilayer microscopic vesicle, very similar to a cell membrane, surrounding an aqueous volume core containing phage. In one embodiment, the phage is within the aqueous core of the liposome. In another embodiment, the phage may be injected into the liposome and carried in one of the lipid layers.

The liposomes may be the encapsulating bodies containing the phage, or such phage may themselves be further encapsulated, e.g., by a thin shell of protective material. In the latter case, the shell may, for example, be compounded to provide a further, temporary protective cover for the liposome, such as a degradable skin, that enhances the lifetime of the liposome in the water system yet dissolves, decays or otherwise breaks down after a certain time, or under certain conditions, releasing the liposomes which may then act on the target organisms.

If liposomes are utilized in the wastewater effluent to house the phage, the concentration of phage in the effluent (i.e., the tank containing the effluent) could be somewhat lower and be from to 0.5×10¹ to 0.5×10⁸ pfu/ml (plaque forming units per milliliter of fluid in the tank), and preferably in an amount of from 1×10⁶ to 1×10¹⁰ pfu/ml. Any range between 0.5×10¹ and 0.5×10⁸ pfu/ml of tank fluid is envisioned by the present disclosure, including about 5×10² to 1×10⁷, and 1×10³ to 1×10⁷, and 1×10⁵ to 1×10⁷, and any ranges within those ranges, such as 5×10² to 1×10⁷ pfu/ml, 1×10³ to 1×10⁸ pfu/ml, 1×10⁴ to 1×10⁷ pfu/ml, and 5×10⁴ to 1×10⁶ pfu/ml, and any range within these ranges. This is the case since the liposomes have better bacterial colony penetration capabilities due to the hydrophillicity of the outer layer of the liposome, and also the increased protection of the phage by the liposome, as explained below. It is noted that the solution including phage and liposomes will likely include the phage inside and outside the liposomes, but the phage which is located inside the liposomes will be better protected.

Some of the environments in the wastewater tank may be inhospitable to phage, so the presence of liposomes in the tank would protect the phage inside the liposomes against potentially hazardous environments to which the phage would otherwise be exposed to, such as various chemicals.

In the event that a time-release of the phage is desired in order to reduce the frequency of phage application, the phage could be microencapsulated or even macroencapsulated into particles of phage-containing solid or semi-solid materials. These materials would slowly hydrolyze and release the phage over a period of time into the wastewater effluent. The concentrations of phage desired in these solid or semi-solid materials would vary depending on the amount of these solid or semi-solid materials in the wastewater effluent, and on the speed of hydrolysis. Ultimately, the desired concentration of phage in the wastewater effluent may be the same as disclosed above, so the concentration of phage in the solid or semi-solid materials would be appropriate to result in such phage concentration in the wastewater effluent based upon the dissolution rate of such solid or semi-solid material.

The concentrations of phage described above are what is to be obtained based upon the addition of phage into the system. However, if the phage that is added reproduces and is effective against the bacteria, the concentrations of phage that are added can then be reduced accordingly.

Phage can be micro-encapsulated, with or without the use of liposomes, to provide further protection to the phage and/or to result in a time-release environment. Micro-encapsulation is a process in which tiny agglomerations of phage are surrounded by a coating to give small capsules. In practice, it will not be just phage that will be encapsulated. Rather, it will be phage in some kind of carrier, such as water, an oil-based solvent, or even a cross-linked saccharide or polymer which will hydrolyze or dissolve in the pipeline fluid, especially the water-based pockets. The size of these microcapsules can be from about 1 micrometer to about 5 millimeters. Techniques to manufacture microcapsules include the air-suspension coating, where phage-containing droplets or particles are suspended in an upward-moving air stream and exposed to the coating material. Alternatively, the phage can be mixed with a liquid material which contains crosslinker, then separated into particles, and then crosslinked to increase viscosity and reduce tackiness. Hydroxypropylmethylcellulose can be such material. Another way to make the microcapsules is to take a phage-containing liquids and put them through a rotating extrusion head containing concentric nozzles. In this process, a jet of core liquid is surrounded by a sheath of wall solution or melt. As the jet moves through the air it breaks, owing to Rayleigh instability, into droplets of core, each coated with the wall solution. While the droplets are in flight, a molten wall may be hardened or a solvent may be evaporated from the wall solution. In spray-drying, the phage is suspended in a polymer solution and becomes trapped in the dried particle when the particle dries. Alternatively, a crosslinking reaction may be what traps the phage in the material.

It is noted that the encapsulant may encapsulate the phage in a carrier, or it can both encapsulate the phage and is also the carrier. Thus, phage in the wastewater effluent can be encapsulated by polymer. Alternatively, phage in the polymer itself forms the microcapsule. Materials that can be used for the encapsulation include cellulose acetate, cellulose acetate butyrate, cellulose acetate phthalate, dextrins, ethyl cellulose, ethylene vinyl acetate, fats, fatty acids, gelatin, glycerides, vegetable gums, hydroxyl propyl cellulose, hydroxypropyl methyl cellulose, hydroxypropyl methyl cellulose phthalate, maltodextrins, methyl cellulose, polylactides, polyethylene glycol, polyvinyl acetate, polyvinyl alcohol, proteins, and starches. The molecular weight/crosslinking of the material can be adjusted for the particular desired hydrolysis resistance and subsequent release of phage. The thickness of the encapsulant can determine the rate of release of the phage as well.

Other materials that can be utilized to form the encapsulant, with crosslinking as necessary, are lecithin, gums, gels, biodegradable or non-biodegradable polymers, such as polylactic acid or polystyrene, organic polymers, combinations of lecithin and organically functionalized lecithin where the functionalization can either be polymer chains, peptides, proteins, lipids, cholesterols or bio receptors. The material may also be multi-block polymers containing hydrophobic and hydrophilic blocks, self-assembled donor:acceptor moieties and micelles, inorganic spheres, rods, cages or particles.

In one embodiment, the capsules may be from about 0.01 micron to about 100 microns. In another embodiment, the capsules have a size of from about 0.01 micron to about 50 microns. In another embodiment, the capsules have sizes from about 0.01 micron to about 20 microns. In another embodiment, the capsules have a size of from about 0.05 micron to about 15 microns. In another embodiment, the capsules have a size of from about 0.1 micron to about 10 microns. In another embodiment, the capsules have a size of about 0.25 micron to about 2 microns. The size of the capsules is measured directly by microscopic techniques.

### Example 1

Pseudomonas Aeruginosa is a film-forming bacteria that can be present in cooling tower waters and other industrial water aqueous systems. Pseudomonas Aeruginosa 12055TM and its corresponding Bacteriophage 12055TM-B3 were purchased from ATCC (American Type Culture Collection). Pseudomonas Aeruginosa 12055TM was obtained in freeze-dried form and a mother stock was created as is well known in the art. It was then inoculated as described below.

Synthetic water solution was prepared to simulate an industrial water system, such as a cooling tower. The synthetic water included water with the following components:

400 ppm Ca as CaCO₃, 150 ppm Mg as CaCO₃, 450 ppm SO₄ (as SO₄), 30 ppm SiO₂ (as SiO₂), 200 ppm M-alkalinity (as CaCO₃), 6 ppm calcium phosphate inhibitor (acrylic-based terpolymer as disclosed in U.S. Pat. No. 6,641,754, titled “Method for controlling scale formation and deposition in aqueous systems,” which is incorporated by reference herein in its entirety), 8 ppm calcium carbonate inhibitor (alkylepoxycarboxylate), 6 ppm o-PO₄ (orthophosphate), and the water was then adjusted to a pH of 8.6 with NaOH. Cooling tower water is present in cooling towers, and making a synthetic version of such water does not require a detailed disclosure herein as it is known in the art.

150 ml of synthetic water solution (as prepared above) was filtered through a 0.22 micron filter to sterilize the solution by filtering unwanted bacteria, and then spiked with 15 ml broth, and such broth contains 5% TSB (Trypticase™ soy broth, Tripticase™ is a trademark of Beckton, Dickinson and Company) sufficient to result in a roughly 10% broth based on weight. The preparation of such broths for inoculation of bacteria is well known in the art and no additional description is necessary. This resulting solution was inoculated with Pseudomonas Aeruginosa 12055TM mother stock to lead to a bacteria concentration of 5.3 E+7 cfu/ml in planktonic form. This solution will be deemed the Control (otherwise referred to as “Solution 0”).

The inoculated solution was divided up and different portions were treated with different amounts of bacteriophage 12055TM-B3 stock to obtain different concentrations of phage, as explained below. The bacteriophage was purchased in freeze-dried form and the stock was prepared according to procedures well known in the art. The bacteriophage in such stock is specific to Pseudomonas Aeruginosa 12055TM. Three solutions at different concentrations were prepared, as delineated below. The number of phage is described as plaque forming units (pfu) per milliliter. The procedure is well known and can be found in, for example, the document titled Titering of Bacterial Viruses, by David B. Fankhausser, and such document is incorporated by reference herein in its entirety.

Solution 1: 1 ml of 8.1 E+7 pfu/ml was mixed into 25 ml of the inoculated solution, resulting in a count of 3.1 E+6 phage/ml for the resulting solution. This leads to a phage (pfu)/bacteria(cfu) ratio of 0.06/1.

Solution 2: 1 ml 8.1 E+6 pfu/ml was mixed into 25 ml of the inoculated solution, resulting in 3.1 E+5 phage (pfu)/ml for the resulting solution. This leads to a phage(pfu)/bacteria(cfu) ratio of 0.006/1.

Solution 3: 1 ml 8.1 E+5 pfu/ml was mixed into 25 ml of the inoculated solution, resulting in 3.1 E+4 pfu/ml for the resulting solution. This leads to a phage(pfu)/bacteria(cfu) ratio of =0.0006/1.

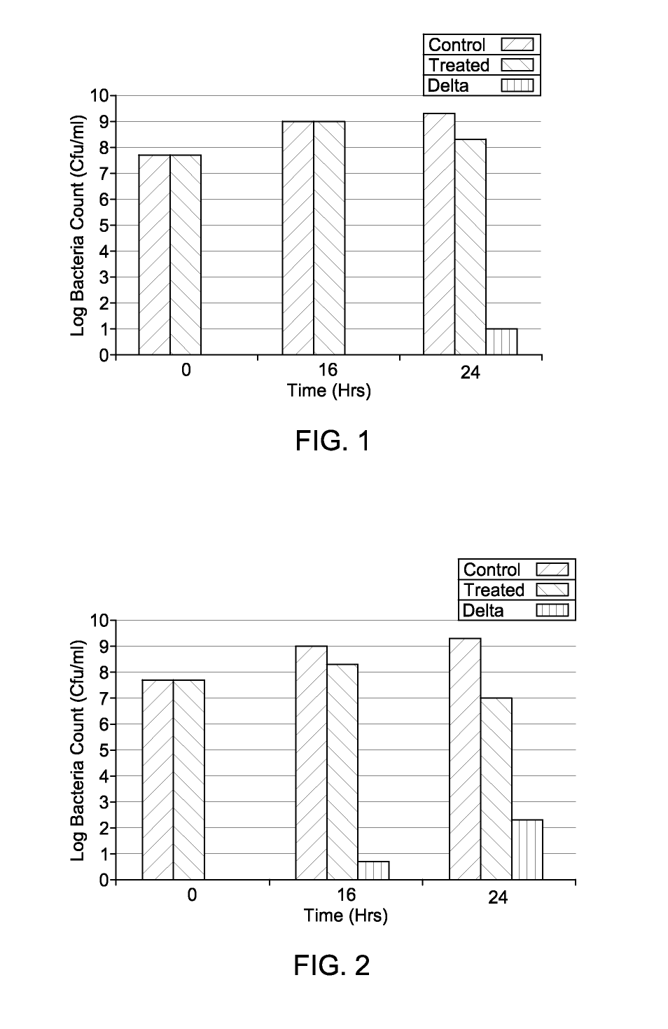

Solutions 0-3 were incubated at 37° C. over a 24 hour interval. Samples were taken at times 0, 16 and 24 hours and counted in a 3M Petrifilm™ count plate (3M Petrifilm™ is a trademark of 3M Company). Results in FIGS. 1-3 show a 1-2 log reduction over these low phage(pfu)/bacteria(cfu) treatment ratios.

FIG. 1 shows a comparison in the amount of bacteria as measured in colony forming units (cfu) per milliliter for both the control (Solution 0), as well as Solution 1. The term “TREATED” in the figures refers to the Solutions which are not the controls. For ease of analysis, the cfu count is graphed as the log of the bacterial count in colony forming units. There is also a third bar that shows the difference between Solution 0 and Solution 1. As shown in FIG. 1, the control had a log of 7.7 at time 0, a log of 9 at 16 hours, and a log of 9.3 at 24 hours. The sample treated with Solution 1 had a log of 7.7 at time 0, a log of 9 at 16 hours, and 8.3 at 24 hours. At times 0 and 16 hours, there was no difference between the control and the sample with Solution 1. However, at 24 hours, there was one log of reduction of the number of bacteria, which means that there was a 90% reduction in bacteria relative to the control.

FIG. 2 is similar to FIG. 1, except that Solution 2 is used instead of Solution 1. At time 0, both the control and Solution 2 had a log of 7.7. At 16 hours, the control showed a log of 9, Solution 2 showed a log of 8.3, and the difference was a log 0.7. At 24 hours, the control exhibited a log of 9.3, Solution 2 exhibited a log of 7, with a change being a log of 2.3. This means that there was a reduction in bacterial count relative to the control of more than 99% after 24 hours.

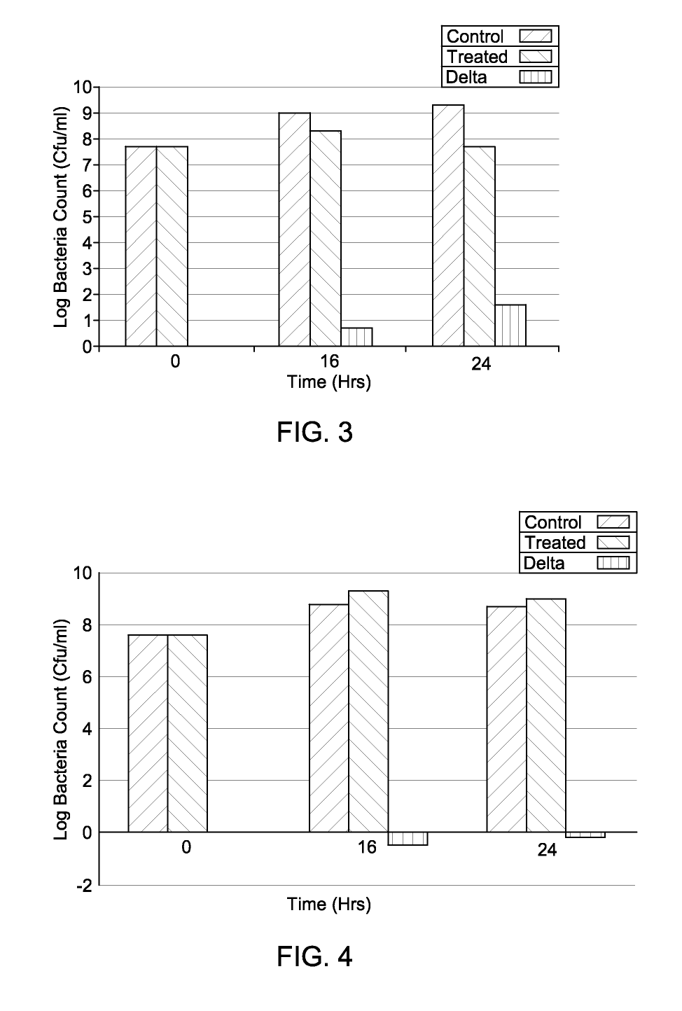

FIG. 3 is similar to FIG. 1, except that Solution 3 is used instead of Solution 1. At time 0, both the control and Solution 2 exhibited a log of 7.7. At 16 hours, the control showed a log of 9, Solution 3 showed a log of 8.3, and the difference was a log 0.7. At 24 hours, the control exhibited a log of 9.3, Solution 3 exhibited a log of 7.7, with a change being a log of 1.6. This means that there was a reduction in bacterial count relative to the control of more than 90% at 24 hours.

### Example 2

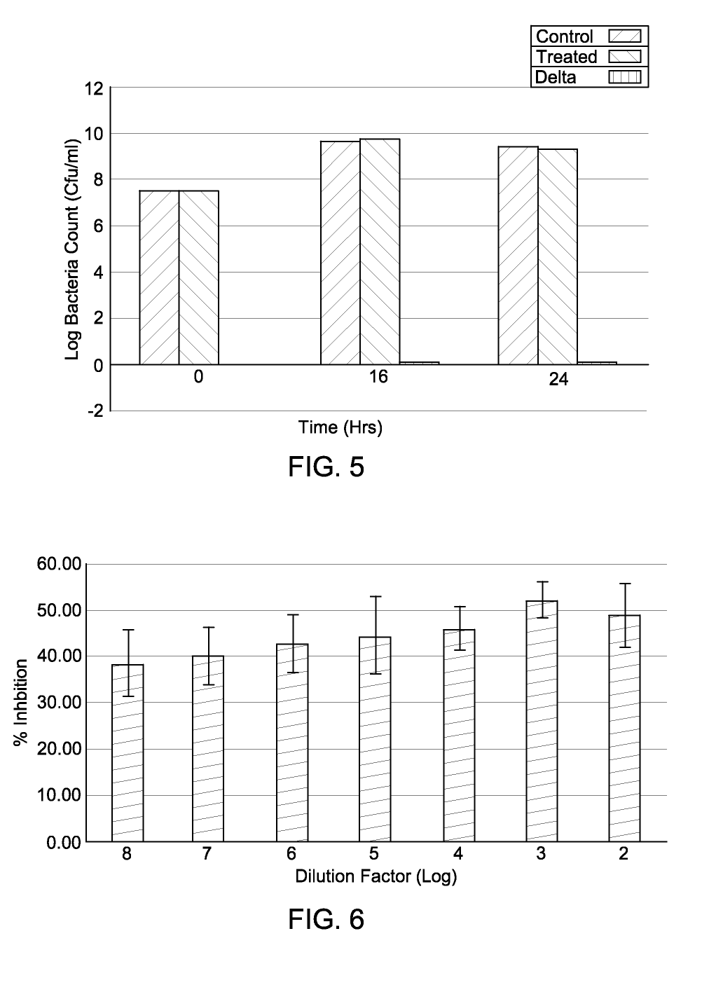

The same procedure was followed as in Example 1 above, except that Solutions 4 and 5 were prepared with an increased amount of phage relative to Solutions 1-3. Solution 4 had a ratio of phage (pfu) to bacteria (cfu) of 0.1/1, and the amount of phage per milliliter was 5.3 E+6 pfu/ml. Solution 5 had a ratio of phage (pfu) to bacteria (cfu) of 0.6/1, and the a mount of phage per milliliter was 3.2 E+7 pfu/ml. FIGS. 4-5 show that this amount of phage appeared to range from a beneficial effect to a detrimental effect. It is believed that if there is too much phage relative to the amount of bacteria, that there may be some mechanism by which the phage will be inhibited in order to avoid completely destroying all of the bacteria, which would mean that the phage would no longer be able to reproduce in such environment.

FIG. 4 is similar to FIG. 1, except that Solution 4 is used instead of Solution 1. At time 0, both the control and Solution 4 exhibited a log of 7.6. At 16 hours, the control showed a log of 8.8, Solution 4 showed a log of 9.3, and the difference was a log 0.5 increase in bacteria. Thus, the treated sample had more bacteria than the control. At 24 hours, the control exhibited a log of 8.8, Solution 4 exhibited a log of 9, which is a log 0.2 increase in bacteria count. Thus, the treated sample had more bacteria than the control. As stated above, a potential inhibitory effect may have caused the phage to have a lesser effect at higher concentrations.

FIG. 5 is similar to FIG. 1, except that Solution 5 is used instead of Solution 1. At time 0, both the control and Solution 5 exhibited a log of 7.7. At 16 hours, the control showed a log of 9.6, Solution 5 showed a log of 9.7, and the difference was a log 0.1 increase in bacteria count. Thus, the treated sample had more bacteria than the control. At 24 hours, the control exhibited a log of 9.4, Solution 5 exhibited a log of 9.3, with a 0.1 log decrease in bacteria count. Thus, the treated sample started with an increase in bacterial count but eventually ended up with a small decrease in bacterial count. As stated above, a potential inhibitory effect may have caused the phage to have a lesser effect at higher concentrations.

### Example 3

A synthetic water solution having the same composition as the synthetic water solution described in Example 1 was filtered through a 0.22 micron filter to sterilize the solution by filtering unwanted bacteria, and then spiked with the same broth described in Example 1 sufficient to result in an approximately 10% broth concentration on a weight basis. This solution was divided into the wells of a 96-well plate and inoculated with Pseudomonas Aeruginosa 12055TM mother stock which is the same as in Example 1. A biofilm of the bacteria was grown at 37° C. over 24 hrs. After rinsing three times with a saline solution (0.85% NaCl), the 96 wells were spiked with 12055TM-B3 bacteriophage stock (the same as used in Example 1), except that it was diluted with additional stock to have 8.1 E+4 (dilution 8) to 8.1 E+10 (dilution 2) phage/ml range present in the wells, and the well plate was then shaken in an incubator at 37° C. for 2 hrs to provide a somewhat dynamic environment. After washing three times with a saline solution, the 96 wells were treated with resauzirine dye, incubated at 37° C. for 2 hrs., and then measured for bacteria growth. As shown in FIG. 6, a roughly 40-50% biofilm reduction was obtained over the 8.1 E+4 to 8.1 E+10 phage(pfu)/ml application range. Since multiple tests were conducted at each dilution factor, the graphs show the average of the results with the range being shown with vertical lines at the top of each graph. Since biofilms are relatively dense sources of bacteria for the phage, it is believe that as much as 1×10¹² phage(pfu) per milliliter could be used to effectively attack the biofilm. Also, the ready availability of bacteria for the phage attack is also believed to allow even 1×10³ phage(pfu) per milliliter of water to be able to effectively attack the biofilm since the phage can use the biofilm to replicate itself into larger numbers.

What is claimed is:

1. A method for remediating bacterially-induced corrosion, environmental damage, and/or process inefficiencies in an industrial process, comprising:
identifying an industrial process where target bacteria adversely affect corrosion, environmental impact, and/or process efficiencies;
identifying the strains of the target bacteria;
obtaining a bacteriophage virulent against one or more of the strains of the target bacteria; and
exposing the target bacteria to the bacteriophage.

2. The method according to claim 1, wherein the target bacteria is exposed to an effective amount of bacteriophage to reduce the amount of target bacteria present in the industrial process.

3. The method according to claim 1, wherein the industrial process comprises at least one selected from the group consisting of: mining, hydraulic fracturing, cooling tower operation, transportation of hydrocarbons in a pipeline, and wastewater treatment.

4. The method according to claim 2, wherein the industrial process comprises mining, and the bacteriophage is sprayed as part of an aqueous solution to surfaces inside a mine which harbor the target bacteria.

5. The method according to claim 2, wherein the industrial process comprises hydraulic fracturing, and the bacteriophage is sprayed as part of an aqueous solution to hydraulically fractured surfaces, or surfaces connected thereto, which harbor the target bacteria.

6. The method according to claim 2, wherein the industrial process comprises a cooling tower operation, and the bacteriophage is added to cooling water in the cooling tower containing target bacteria.

7. The method according to claim 2, wherein the industrial water process comprises piping hydrocarbons, and the bacteriophage is added to fluid inside of a pipeline containing the hydrocarbons.

8. The method according to claim 2, wherein the industrial process comprises wastewater treatment, and the bacteriophage is added to aqueous effluent from a wastewater treatment plant containing target bacteria.

9. The method according to claim 4, wherein at least some of the bacteriophage are enclosed in liposomes.

10. The method according to claim 4, wherein the target bacteria are also exposed to a biocide.

11. The method according to claim 2, wherein the industrial process comprises mining or hydraulic fracturing, and the bacteriophage is sprayed as part of a foam or gel.

12. The method according to claim 4, wherein the aqueous solution comprises 1×10³ to 1×10¹² plaque forming units of bacteriophage per milliliter of the aqueous solution.

13. The method according to claim 6, wherein the bacteriophage is added to the cooling water in an amount sufficient to obtain a concentration of the bacteriophage in the cooling water of 1×10³ to 1×10¹² plaque forming units per milliliter of the cooling water.

14. The method according to claim 7, wherein the bacteriophage is added to the fluid inside of the pipeline in an amount sufficient to obtain a concentration of the bacteriophage in the fluid of 1×10³ to 1×10¹² plaque forming units per milliliter of the fluid.

15. The method according to claim 8, wherein the bacteriophage is added to the aqueous effluent in an amount sufficient to obtain a concentration of the bacteriophage in the aqueous effluent of 1×10¹ to 1×10⁸ plaque forming units per milliliter of the aqueous effluent.

16. An aqueous composition comprising bacteriophage encapsulated in at least one selected from the group consisting of: liposomes, foam, and gel.

17. The aqueous composition according to claim 16, further comprising a biocide.
